(19) United States
(12) Patent Application Publication
(10) Pub. No.: US 2020/0037145 A1
(43) Pub. Date: Jan. 30, 2020

(54) First Node, Second Node, Radio Network Node and Mobility Management Entity and Methods Performed Thereby for Handling Assistance Data About a Location of a Second Node

(71) Applicant: Telefonaktiebolaget LM Ericsson (publ), Stockholm (SE)

(72) Inventors: Fredrik Gunnarsson, Linköping (SE); Sara Modarres Razavi, Linköping (SE); Henrik Rydén, Solna (SE); Ritesh Shreevastav, Upplands Väsby (SE); Xin Zhang, Unterhaching (DE)

(21) Appl. No.: 16/086,551

(22) PCT Filed: Aug. 14, 2018
(86) PCT No.: PCT/SE2018/050821

§ 371 Date: Sep. 19, 2018

Related U.S. Application Data
(60) Provisional application No. 62/569,664, filed on Oct. 9, 2017.

(51) Int. Cl. H04W 8/02; H04W 4/06; H04W 16/28; H04W 4/50

(52) U.S. Cl. CPC H04W 8/02; H04W 4/06; G01S 5/0236; H04W 4/50; H04W 16/28

(57) ABSTRACT

A method by a first node (101) for handling assistance data about a location of a second node (102) is described herein. The first and the second node (102) operate in a wireless communications network (100). The first node (101) determines (305) a first set of the assistance data to be provided to the second node (102) via unicast, and a second set of the assistance data to be provided via broadcast. The determining (301) is based on one or more characteristics of at least one of: the second node (102), the assistance data, the wireless communications network (100), and the radio coverage. The first node (101) then sends (307), to at least one of: the second node (102) and a third node (103) operating in the wireless communications network (100), the first set of the assistance data via unicast, and the second set of the assistance data via broadcast.

### TECHNICAL FIELD

The present disclosure relates generally to a first node and methods performed thereby for handling assistance data about a location of a second node. The present disclosure also relates generally to the second node and methods performed thereby for the handling assistance data about the location of the second node. The present disclosure further relates generally to a radio network node and methods performed thereby for the handling assistance data about the location of the second node. The present disclosure additionally relates generally to a mobility management entity and methods performed thereby for the handling assistance data about the location of the second node.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., evolved Node B (“eNB”), “eNodeB”, “NodeB”, “B node”, gNB, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### Positioning

Positioning in LTE may be supported by the architecture in in FIG. 1, with direct interactions between a UE 10 and a location server, the Evolved Serving Mobile Location Center (E-SMLC) 11, via the LTE Positioning Protocol (LPP) 12. Moreover, there there may be also interactions between the location server and the eNodeB 13 via the LTE Positioning Protocol A (LPPa) protocol 14, to some extent supported by interactions between the eNodeB 13 and the UE 10 via the Radio Resource Control (RRC) protocol 15. The eNodeB 40 and the E-SMLC 20 may also communicate with a Mobility Management Entity (MME) 16, which in turn communicates with a Gateway Mobile Location Centre (GMLC) 17.

In LTE, as described e.g., in 3GPP Technical Specification 36.305, v.14.1.0, the following positioning techniques may be considered. A first technique is the Enhanced Cell Identifier (ID). Through this technique, cell ID information may be used to associate the UE to the serving area of a serving cell, and then additional information may be used to determine a finer granularity position.

Another technique is assisted Global Navigation Satellite System (GNSS). GNSS may be understood to encompass all systems that may provide worldwide positioning based on satellites, including, for example, the Global Positioning System (GPS), the Global Navigation Satellite System (GLONASS) and Galileo. In this technique, GNSS information may be retrieved by the UE, and it may be supported by assistance information provided to the UE from the Evolved Serving Mobile Location Center (E-SMLC).

Another technique is the Observed Time Difference of Arrival (OTDOA). In this technique, the UE may estimate the time difference of reference signals from different base stations and may send the result of the estimation to the E-SMLC for multilateration.

Yet another technique is the Uplink TDOA (UTDOA). In this technique, the UE may be requested to transmit a specific waveform that may be detected by multiple location measurement units, e.g., an eNB, at known positions. These measurements may be forwarded to E-SMLC for multilateration.

In LTE Release 15 positioning Work Item (WI), one main objective is to provide support for positioning assistance information, e.g., GNSS assistance data, OTDOA or UTDOA assistance data, via broadcast or unicast. Assistance data may be understood as the information available at the network, which may be required by the UE, to perform the measurement that may be required for a particular positioning method. For example, for Assisted-GNSS (A-GNSS), and Real Time Kinematics (RTK) and UE-based OTDOA, the support for broadcasting positioning assistance information may be achieved via specifying System Information Block or Blocks (SIB/SIBs) to provide signaling information. Another method for broadcasting information may be to use Evolved Multimedia Broadcast Multicast Services (eMBMS), also known as LTE broadcast. As mentioned, there are many positioning assistance data which may be broadcasted by eNBs to the UEs in the network. The UE may either freely, or via some encryption process, be able to use this data to do its own positioning. There has not been any particular agreement in 3GPP until now on how this broadcast may need to look like and what type of data it may need to contain.

Existing methods to provide assistance data are inflexible and ineffective and may result in a waste of time, energy, processing, and radio resources, which may in turn result in increased latency, and decreased capacity in a wireless network, as well as battery drainage in the in devices involved.

### SUMMARY

It is an object of embodiments herein to improve the handling of assistance data about a location of a node in a wireless communications network.

According to a first aspect of embodiments herein, the object is achieved by a method, performed by a first node. The method is for handling assistance data about a location of a second node. The first node and the second node operate in a wireless communications network. The first node determines a first set of the assistance data to be provided to the second node via unicast, and a second set of the assistance data to be provided to the second node via broadcast. The determining is based on one or more characteristics of at least one of: the second node, the assistance data, the wireless communications network, and the radio coverage of the second node. The first node then sends, to at least one of: the second node and a third node operating in the wireless communications network, the first set of the assistance data via unicast, and the second set of the assistance data via broadcast.

According to a second aspect of embodiments herein, the object is achieved by a method, performed by the second node. The method is for handling assistance data about the location of the second node. The second node operates in the wireless communications network. The second node retrieves, from the first node operating in the wireless communications network, the first set of the assistance data via unicast, and the second set of the assistance data via broadcast. The retrieving is based on the one or more characteristics of at least one of: the second node, the assistance data, the wireless communications network, and the radio coverage of the second node. The second node then initiates using at least one of the retrieved first set of the assistance data and second set of the assistance data, to facilitate a positioning measurement.

According to a third aspect of embodiments herein, the object is achieved by a method, performed by a radio network node. The method is for handling assistance data about the location of the second node. The radio network node and the second node operate in a wireless communications network. The radio network node receives, from the first node operating in the wireless communications network the first set of the assistance data to be provided to the second node via unicast, and the second set of the assistance data to be provided to the second node via broadcast. The receiving is based on the one or more characteristics of at least one of: the second node, the assistance data, the wireless communications network, and the radio coverage of the second node. The radio network node then sends, to the second node, the first set of the assistance data via unicast, and the second set of the assistance data via broadcast.

According to a fourth aspect of embodiments herein, the object is achieved by a method, performed by a mobility management entity. The method is for handling assistance data about the location of the second node. The mobility management entity and the second node operate in a wireless communications network. The mobility management entity receives, from the first node operating in the wireless communications network the first set of the assistance data to be provided to the second node via unicast, and the second set of the assistance data to be provided to the second node via broadcast. The receiving is based on the one or more characteristics of at least one of: the second node, the assistance data, the wireless communications network, and the radio coverage of the second node. The mobility management entity then sends, to the second node, the first set of the assistance data via unicast, and the second set of the assistance data via broadcast.

According to a fifth aspect of embodiments herein, the object is achieved by a first node, configured to handle assistance data about the location of the second node. The first node and the second node are configured to operate in the wireless communications network. The first node is further configured to determine the first set of the assistance data to be provided to the second node via unicast, and the second set of the assistance data to be provided to the second node via broadcast. To determine is configured to be based on the one or more characteristics of at least one of: the second node, the assistance data, the wireless communications network, and the radio coverage of the second node. The first node is also configured to send, to at least one of: the second node and the third node configured to operate in the wireless communications network, the first set of the assistance data via unicast, and the second set of the assistance data via broadcast.

According to a sixth aspect of embodiments herein, the object is achieved by a second node, configured to handle assistance data about the location of the second node. The second node is further configured to operate in the wireless communications network. The second node is further configured to retrieve, from the first node configured to operate in the wireless communications network, the first set of the assistance data via unicast, and the second set of the assistance data via broadcast. To retrieve is configured to be based on the one or more characteristics of at least one of: the second node, the assistance data, the wireless communications network, and the radio coverage of the second node. The second node is further configured to initiate using at least one of the first set of the assistance data and second set of the assistance data configured to be retrieved, to facilitate the positioning measurement.

According to a seventh aspect of embodiments herein, the object is achieved by a radio network node, configured to handle assistance data about the location of the second node. The radio network node and the second node are further configured to operate in the wireless communications network. The radio network node is further configured to receive, from the first node configured to operate in the wireless communications network the first set of the assistance data to be provided to the second node via unicast, and the second set of the assistance data to be provided to the second node via broadcast. To receive is configured to be based on the one or more characteristics of at least one of: the second node, the assistance data, the wireless communications network, and the radio coverage of the second node. The radio network node is further configured to send, to the second node, the first set of the assistance data via unicast, and the second set of the assistance data via broadcast.

According to an eighth aspect of embodiments herein, the object is achieved by a mobility management entity, configured to handle assistance data about the location of the second node. The mobility management entity and the second node are further configured to operate in the wireless communications network. The mobility management entity is further configured to receive, from the first node configured to operate in the wireless communications network the first set of the assistance data to be provided to the second node via unicast, and the second set of the assistance data to be provided to the second node via broadcast. To receive is configured to be based on the one or more characteristics of at least one of: the second node, the assistance data, the wireless communications network, and the radio coverage of the second node. The mobility management entity is further configured to send, to the second node, the first set of the assistance data via unicast, and the second set of the assistance data via broadcast.

By the first node determining the first set of the assistance data to be provided to the second node via unicast, and the second set of the assistance data to be provided to the second node via broadcast based on the one or more characteristics of at least one of: the second node, the assistance data, the wireless communications network, and the radio coverage of the second node, the first node is enabled to send the assistance data with enhanced efficiency and flexibility. For example, information which may be common to several wireless devices may be shared via broadcast, whereas information which may be dedicated to user may be transmitted via unicast. Similarly, information which may be more security sensitive may be transmitted via unicast, as well as information that may seldom need to be updated. Also, depending upon the network load, a decision may be made on what proportion should be used for unicast and what proportion for broadcast. Therefore, the wireless second node, the first node, the radio network node and the mobility management entity may save power as well processing and time-frequency resources.

### BRIEF DESCRIPTION OF THE DRAWINGS

Examples of embodiments herein are described in more detail with reference to the accompanying drawings, according to the following description.

FIG. 1 is a schematic diagram illustrating an LTE positioning architecture.

FIG. 2 is a schematic diagram illustrating two non-limiting examples, in panels a) and b), respectively, of embodiments of a wireless communications network, according to embodiments herein.

FIG. 3 is a flowchart depicting a method in a first node, according to embodiments herein.

FIG. 4 is a flowchart depicting a method in a second node, according to embodiments herein.

FIG. 5 is a flowchart depicting a method in a radio network node, according to embodiments herein.

FIG. 6 is a flowchart depicting a method in a mobility management entity, according to embodiments herein.

FIG. 7 is a flowchart depicting a method in a second node, according to embodiments herein.

FIG. 8 is a flowchart depicting a method in a first node, according to embodiments herein.

FIG. 9 is a flowchart depicting a method in a wireless communications network, according to embodiments herein.

FIG. 10 is a signalling diagram depicting an example of a method in a first node and a second node, according to embodiments herein.

FIG. 11 is a signalling diagram depicting an example of a method in a first node, a radio network node, and a second node, according to embodiments herein.

FIG. 12 is a signalling diagram depicting an example of a method in a first node, a radio network node and a second node, according to embodiments herein.

FIG. 13 is a schematic block diagram illustrating embodiments of a first node, according to embodiments herein.

FIG. 14 is a schematic block diagram illustrating embodiments of a second node, according to embodiments herein.

FIG. 15 is a schematic block diagram illustrating embodiments of a radio network node, according to embodiments herein.

FIG. 16 is a schematic block diagram illustrating embodiments of a mobility management entity, according to embodiments herein.

FIG. 17 is a flowchart depicting a method in a first node, according to an example related to embodiments herein.

FIG. 18 is a flowchart depicting a method in a second node, according to an example related to embodiments herein.

FIG. 19 is a schematic block diagram illustrating a wireless network, according to embodiments herein.

FIG. 20 is a schematic block diagram illustrating a user equipment, according to embodiments herein.

FIG. 21 is a schematic block diagram illustrating a virtualization environment, according to embodiments herein.

FIG. 22 is a schematic block diagram illustrating a telecommunication network connected via an intermediate network to a host computer, according to embodiments herein.

FIG. 23 is a generalized block diagram of a host computer communicating via a base station with a user equipment over a partially wireless connection, according to embodiments herein.

FIG. 24 is a flowchart depicting embodiments of a method in a communications system including a host computer, a base station and a user equipment, according to embodiments herein.

FIG. 25 is a flowchart depicting embodiments of a method in a communications system including a host computer, a base station and a user equipment, according to embodiments herein.

FIG. 26 is a flowchart depicting embodiments of a method in a communications system including a host computer, a base station and a user equipment, according to embodiments herein.

FIG. 27 is a flowchart depicting embodiments of a method in a communications system including a host computer, a base station and a user equipment, according to embodiments herein.

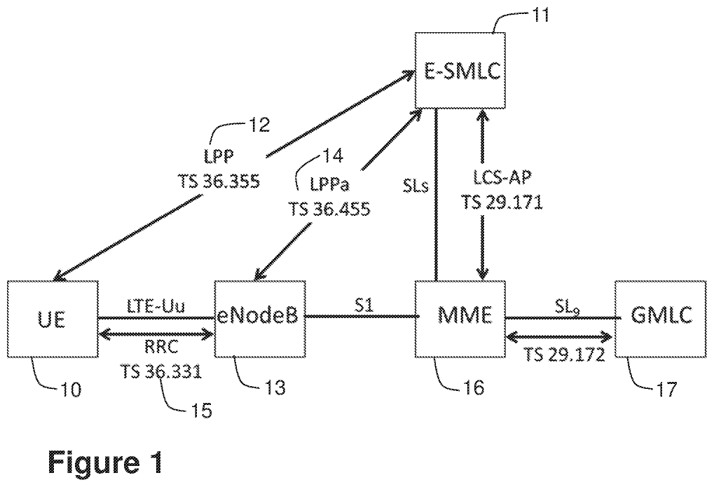

### DETAILED DESCRIPTION

As part of developing embodiments herein, certain challenge(s) that currently exist and may be associated with use of at least some of the existing methods, and that may addressed by embodiments herein, will first be identified and discussed.

Currently, there is no SIB defined for the purpose of positioning in LTE. As there are several different categories of assistance data that may be reported, properly designing such SIB is not a trivial task. On the other hand, the size of some of these assistance information data varies a lot, with some having extensively large data sets. Also, the period during which they may remain as valid data at the device side may vary from a few seconds up to even a six-month time frame. Therefore, means to send the assistance data in an efficient manner is still an open question.

Certain aspects of the present disclosure and their embodiments may provide solutions to these or other challenges. There are, proposed herein, various embodiments which address one or more of the issues disclosed herein. Embodiments herein may be understood to provide an efficient combination of unicast-broadcast transmission of assistance information, taking care of the explicit characteristic of the data into account. Embodiments herein may be understood to relate to providing an efficient and optimized framework using a combination of unicast and broadcast methods of transmission, in order to provide timely assistance data with user differentiation, while avoiding frequently broadcasting large sets of data, which may be valid for long period of time. Particular embodiments herein may be understood to be related to provisioning of positioning assistance data via combined unicast and broadcast.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

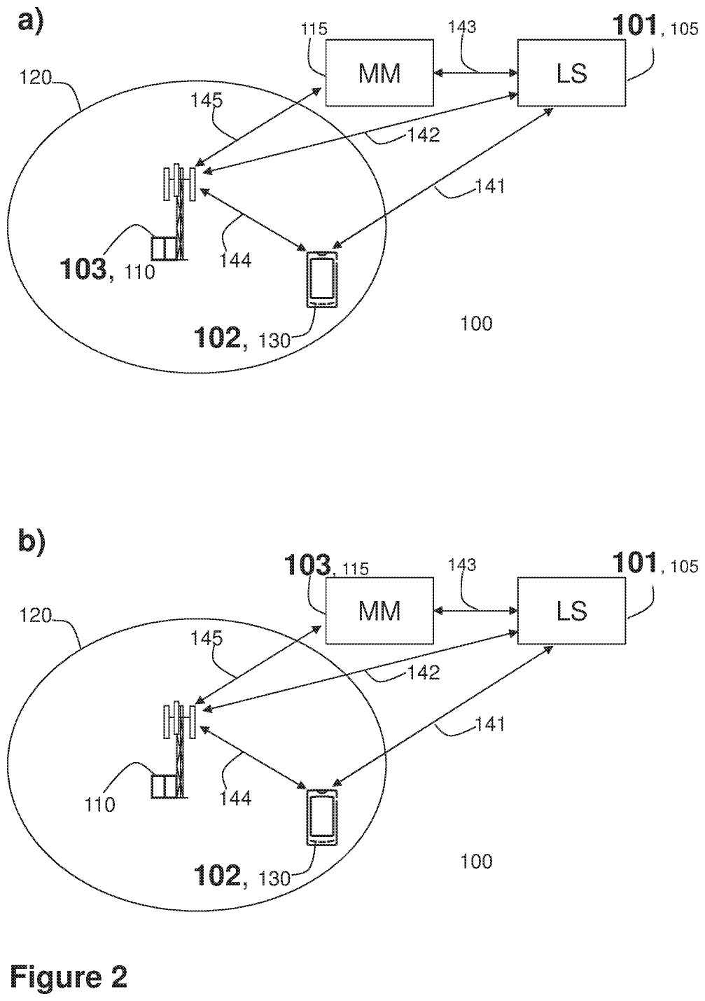

FIG. 2 depicts a non-limiting example, in each of panels a) and b) of a wireless communications network 100, sometimes also referred to as a wireless communications system, cellular radio system, or cellular network, in which embodiments herein may be implemented. The description provided herein for FIG. 2 applies equally to panels a) and b), unless noted otherwise. The wireless communications network 100 may typically be a Long-Term Evolution (LTE), e.g. LTE Frequency Division Duplex (FDD), LTE Time Division Duplex (TDD), LTE Half-Duplex Frequency Division Duplex (HD-FDD), LTE operating in an unlicensed band, or a 5G system, 5G network, or Next Gen System or network. The wireless communications network 100 may also support other technologies such as, for example, a Wide Code Division Multiplexing Access (WCDMA), Universal Terrestrial Radio Access (UTRA) TDD, Global System for Mobile Communications (GSM) network, GSM Enhanced Data rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 3GPP LTE has been used in this disclosure to exemplify embodiments herein, this should not be seen as limiting the scope of the embodiments herein to only the aforementioned system. Other wireless systems, especially 5G/NR, WCDMA, WiMax, UMB and GSM, may also benefit from exploiting the ideas covered within this disclosure.

The wireless communications network 100 may be considered a positioning architecture.

The wireless communications network 100 comprises a plurality of nodes, whereof a first node 101, a second node 102 and at least a third node 103 are depicted in the non-limiting example of FIG. 2. The first node 101 may be a first network node which may have positioning capability, such as a Location Server (LS) 105. In LTE, for example, the location server 105 may be referred to as E-SMLC, and in 5G, as the Location Management Function (LMF). The first node 101 may serve and support the second node 102 for positioning purposes. The second node 102 may be a wireless device, such as the wireless device 130 described below. The third node 103 may be a second network node, such as a radio network node 110 described below, e.g., a base station, which is depicted in the non-limiting example of panel a) in FIG. 2, or a third network node 115, such as a mobility management (MM) entity, as depicted in the non-limiting example of panel b) in FIG. 2. In LTE, the MM entity may be denoted the Mobility Management Entity (MME), and in 5G it may be denoted Access and Mobility Management Function (AMF). In examples wherein the third node 103 is a radio network node 110, the third node 103 may serve the second node 102. It may be understood that in some examples herein, any reference to the third node 103 may equally refer to the radio network node 110 and the third network node 115.

In other examples which are not depicted in FIG. 2, any of the first node 101 and the third node 103 may be a distributed node, such as a virtual node in the cloud, and may perform its functions entirely on the cloud, or partially, in collaboration with a radio network node.

The wireless communications network 100 comprises a plurality of radio network nodes, whereof a radio network node 110 is depicted in the non-limiting example of FIG. 2. The radio network node 110 may be a transmission point such as a radio base station, for example an eNB, a gNB, or any other network node with similar features capable of serving a wireless device, such as a user equipment or a machine type communication device, in the wireless communications network 100.

The wireless communications network 100 covers a geographical area which may be divided into cell areas, wherein each cell area may be served by a radio network node, although, one radio network node may serve one or several cells. In the non-limiting example depicted in FIG. 2, the radio network node 110 serves a cell 120. The radio network node 110 may serve receiving nodes, such as wireless devices, with a plurality of beams, e.g., in NR.

The radio network node 110 may be of different classes, such as, e.g., macro base station, home base station or pico base station, based on transmission power and thereby also cell size. The radio network node 110 may support one or several communication technologies, and its name may depend on the technology and terminology used. In LTE, the network node 110 may be referred to as an eNB. In G/NR, the network node 110 may be referred to as a gNB and may be directly connected to one or more core networks, which are not depicted in FIG. 2.

A plurality of devices, or wireless devices are located in the wireless communication network 100, whereof a wireless device 130, which may also be referred to as a device 130, is depicted in the non-limiting example of FIG. 2. The wireless device 130 comprised in the wireless communications network 100 may be a wireless communication device such as a UE, or a 5G UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet computer, sometimes referred to as a tablet with wireless capability, Machine-to-Machine (M2M) device, device equipped with a wireless interface, such as a printer or a file storage device, modem, or any other radio network unit capable of communicating over a radio link in a communications system. The wireless device 130 comprised in the wireless communications network 100 is enabled to communicate wirelessly in the wireless communications network 100. The communication may be performed e.g., via a RAN, and possibly the one or more core networks, which may comprised within the wireless communications network 100.

The first node 101 may be configured to communicate within the wireless communications network 100 with the second node 102 over a first link 141, e.g., a radio link. The first node 101 may be configured to communicate within the wireless communications network 100 with the radio network node 110, as the third node 103, over a second link 142, e.g., a radio link. The first node 101 may be configured to communicate within the wireless communications network 100 with the third network node 115, as the third node 103, over a third link 143, e.g., a wired link. The second node 102 may be configured to communicate within the wireless communications network 100 with the radio network node 110, as the third node 103, over a fourth link 144, e.g., a radio link. The radio network node 110 may be configured to communicate within the wireless communications network 100 with the third network node 115 over a fifth link 145, e.g., a wired link or a radio link.

In general, the usage of “first”, “second”, “third”, “fourth” and/or “fifth” herein may be understood to be an arbitrary way to denote different elements or entities, and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Embodiments herein will now be described with some non-limiting examples. In the following description any reference to a/the device, target device, and/or a/the device may be understood to relate to the second node 102 or the wireless device 130, and any reference to a/the location server and/or location server 105 may be understood to relate to the first node 101. Any reference to a/the MME entity and/or a/the MME entity may be understood to relate to the third network node 115 as third node 103. Any reference to a/the base station and/or a/the base station, and/or a/the radio base station may be understood to relate to the radio network node 110. Any of the examples provided here may be understood to be able to be combined with the embodiments herein, described earlier.

More specifically, the following are: a) embodiments related to a first node, which may be a network node such as the location server 105, e.g., an E-SMLC, b) embodiments related to a second node, which may be a device or wireless device such as the wireless device 130, e.g., a UE; c) embodiments related to a third node, which may be a radio network node such as the radio network node 110, e.g., an eNB and d) embodiments related to a third network node 115, which may be an MME, such as the MME 115.

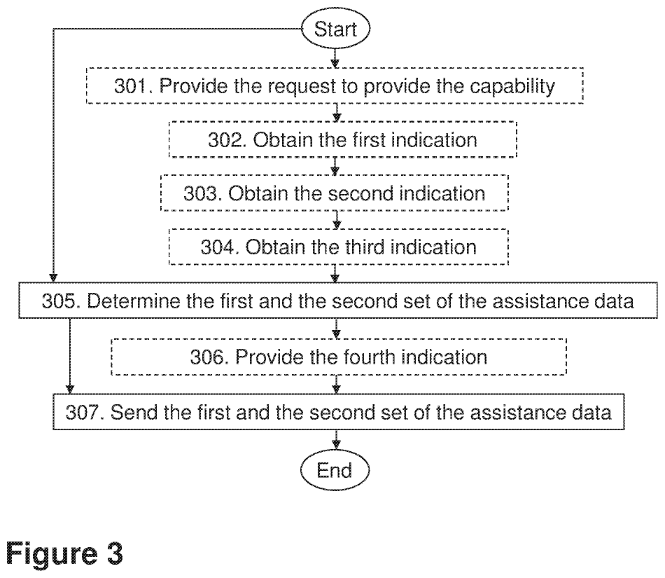

Embodiments of a method, performed by the first node 101, will now be described with reference to the flowchart depicted in FIG. 3. The method is for handling assistance data about a location of the second node 102. The first node 101 and the second node 102 operate in the wireless communication network 100. In some examples, the first node 101 may be the location server 105 and the second node 102 may be the wireless device 130.

In some embodiments all the actions may be performed. In some embodiments, one or more actions may be optional. In FIG. 3, an optional action is indicated with dashed lines. It should be noted that the examples herein are not mutually exclusive. Several embodiments are comprised herein. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 3.

Action 301

During the course of operations in the wireless communications network 100, determining of a position of, or by, the second node 102, may necessary or desired. The first node 101, as a location server, may, either in anticipation of, or in response to a request from the second node 102, may have determined that it may need to provide assistance data to the second node 102 that may be required for different positioning methods, such as, for example, OTDOA, A-GNSS and RTK. Assistance data may also be referred to herein as positioning assistance data.

In order to be able to determine which assistance information to provide to the second node 102 and how to provide it to it, in this Action 301, the first node 101 may provide a request, to the second node 102, to provide a capability of the second node 102. The capability is about positioning.

Providing may be understood as, e.g., sending. The providing may be implemented, for example, via the first link 141.

The capability about positioning, may be for example, whether or not the second node 102 supports detection of positioning broadcast information while in connected mode. Positioning broadcast information may be understood as assistance information which may be broadcasted by a radio network node, such as the radio network node 110, to all the devices in its service area. Another example of the capability about positioning may be particularly related to assistance data provisioning support. Assistance data provisioning support may be understood as a particular support from the network to efficiently assist the capable target devices which may require positioning assistance data to obtain this assistance information from both unicast and broadcast means. Yet another example of capability about positioning may be support for one or more satellite systems, such as, e.g., GPS, GLONASS, GALILEO, BeiDou, and GNSS RTK.

By performing the determining in this Action 301, the first node 101 may be enabled to receive the requested capability of the second node 102 regarding the positioning, and ultimately determine which assistance data to provide to the wireless device 130, and how to provide it, so that the wireless device 130 may be able to appropriately receive and handle the assistance data.

Action 302

In this Action 302, the first node 101 may obtain, from the second node 102, a first indication indicating the capability the second node 102, the capability being about positioning.

Obtaining may be understood as receiving, for example, via the first link 141.

In embodiments wherein Action 301 may have been performed, the obtaining in this Action 302 of the first indication may be based on the provided request in Action 301. However, the second node 102 may have also autonomously provided the first indication, without being any request sent by the first node 101, e.g., when first connecting to the wireless communications network 100.

The first indication may indicate, e.g., whether or not the second node 102 supports detection of positioning broadcast information while in connected mode. The first indication may be, for example, a capability signalling report from the second node 102 indicating the support of broadcast positioning information and, optionally, the encryption procedure.

Action 303

In this Action 303, the first node 101 may obtain, from the second node 102, a second indication indicating a scope of assistance data to be requested by the second node 102.

In some examples, the scope of the assistance data may comprise at least one of: a type of the assistance data, a use the assistance data is requested for, and a method of positioning the assistance data is requested for.

The second indication may be, for example, assistance information signalling in respect to a particular method and the type of assistance data needed.

By obtaining the second indication in this Action 302, the first node 101 may be enabled to better determine which assistance data to provide to the wireless device 130, and also how to provide it, e.g., based on the nature of the assistance data, so that the wireless device 130 may be able to appropriately receive and handle the assistance data.

Action 304

In this Action 304, the first node 101 may obtain, from the third node 103, at least a third indication. The third indication may indicate at least one of: a load of the wireless communications network 100, and an efficiency of provisioning of the assistance data to the second node 102.

The load may be understood as e.g., the network load. For example, the load may be the number of connected users. In another example, the load may be the resource utilization.

The efficiency may be understood to refer to how efficient the assistance data provisioning may be via broadcast and unicast. For example, the efficiency may be understood as how many radio resources may be needed to send the data. That is, how well the time-frequency resources, and/or power resources may be used when sending the data via unicast, in comparison to sending the data via broadcast.

The third indication may be, for example, a signalling from the third node 103 stating the load of the third node 103 in accepting the broadcast positioning assistance information.

By obtaining the third indication in this Action 303, the first node 101 may be enabled to better determine how to schedule the assistance data via broadcast, so that the third node 103 may appropriately receive and handle the broadcast assistance data.

Action 305

According to the foregoing, the first node 101 may have gathered information comprising one or more of: how efficient the assistance data provisioning may be via broadcast and unicast, how frequent different parts of the assistance data may be valid for, and how quickly after request the second node 102 may need the assistance data, the network load, the interest in different parts of the assistance data, the radio condition information provided by the second node 102 in the assistance data request, the potential beamforming gain of unicast and broadcast transmission, whether the second node 102 supports detection of positioning broadcast information while in connected mode. The information may have been retrieved from base stations and/or mobility management entities.

Once the first node 101 may have obtained any of the first, second and/or third indications, the first node 101 may then decide how to provide the assistance data to the second node 102, that is, it may perform a unicast/broadcast provisioning determination.

In this Action 305, the first node 101 determines a first set of the assistance data to be provided to the second node 102 via unicast, and/or a second set of the assistance data to be provided to the second node 102 via broadcast. The determining 301 is based on one or more characteristics of at least one of: the second node 102, the assistance data, the wireless communications network 100, and the radio coverage of the second node 102.

Unicast may be understood as unicast signalling or transmission. Broadcast may be understood as broadcast signalling or transmission. Determining may be understood as e.g., calculating.

With regards to the more characteristics, for example, at least one or more of the following options may apply. In some embodiments, according to a first option, the one or more characteristics of the second node 102 may comprise the capability of the second node 102, as described above, which may have been obtained in Action 301. For example, devices not capable of obtaining broadcasted positioning assistance data information while in connected may get all positioning assistance data via either unicast or broadcast. Devices not capable of obtaining broadcasted positioning assistance data information while in connected mode may need to move between connected mode and idle mode if provided with information via both unicast and broadcast.

In some embodiments, according to a second option, the one or more characteristics of the assistance data may comprise at least one of: a) information on a validity of the first set of the assistance data and second set of the assistance data, e.g., a validity of each of the first set of the assistance data and the second set of the assistance data, and b) an interest on the first set of the assistance data and second set of the assistance data. For example, information common to more users than a threshold may be considered for broadcast provisioning. Information common to fewer users than a threshold may be considered for unicast provisioning.

The validity may be understood as a length of time during which the assistance data, either the first set or the second set, may be used for, and after which the assistance data may need to be updated. Information with long validity and that may be needed more quickly than the validity time, may be provisioned via unicast unless the demand for the information is high.

The one or more characteristics of the assistance data may also comprise, for example, a security sensitivity of the assistance data, such that for example, sensitive and critical information, such as a security key to the UE may be determined to be sent to the second node 102 only via a unicast mechanism. The one or more characteristics of the assistance data may also comprise, in another example, a priority of the assistance data, such that for example, data with high priority may be determined to be unicasted to the second node 102.

In some embodiments, according to a third option, the one or more characteristics of the wireless communications network 100 may comprise at least one of: the load of the wireless communications network 100 and the efficiency of provisioning of the assistance data to the second node 102, as described above, which may have been obtained in Action 303. As a baseline approach, information may be provided via the most efficient provisioning if the resource availability allows.

In some embodiments, according to a fourth option, the one or more characteristics of the radio coverage of the second node 102 may comprise one of: a) a potential beamforming gain of a unicast transmission or a broadcast transmission, and b) a radio condition information provided by the second node 102 in a request for the assistance data. The potential beamforming gain may be understood to be dependent on a number of antennas at the network node 110, e.g., a BS. It may be understood that, for example, if the potential, that is, expected beamforming gain is higher for e.g., the unicast transmission, the first node 101 may base its determine to have more relevant assistance data provided to the second node 102 via unicast. The radio condition information, may be, for example, the coverage level of the beam, the quality of the received signal strength of the serving beam, etc. Devices such as the second node 102 may typically have better radio condition for unicast reception, especially with the beamforming gain expected in 5G. Therefore, based on the radio condition for each device, in some situations it may be more efficient from a network perspective to have e.g., two unicast transmissions than a single broadcast transmission.

Depending upon the network load and the assistance data provisioning support information received from the second node 102, the first node 101 may decide which part may be beneficial to send via unicast and which via broadcast. If the network has enough capacity, it may be beneficial to send the assistance data via dedicated/unicast, else it may be sent via the broadcast mechanism.

Based upon the device subscription, the first node 101 may decide which which methods to use and/or when. For example, for the user which has full subscription, a frequent update and all the needed data may need to be available frequently. However, for a user which has only partial subscription, only basic info may be sufficient. Thus, the network, that is, the first node 101, may decide to broadcast the basic information whereas it may decide to provide the high granular data only via unicast.

In some embodiments, according to a fifth option, the one or more characteristics of the second node 102 may have been indicated by the obtained first indication in Action 302.

In other embodiments, according to a sixth option, the one or more characteristics of the assistance data may have been indicated by the obtained second indication in Action 303.

In some embodiments, the one or more characteristics of the wireless communications network 100 may be indicated by the obtained third indication.

In some embodiments, based on the determining in this Action 305, the first set of the assistance data may comprise at least one of: i) data supported by a lower number of devices in the wireless communications network 100 than the data in the second set of assistance data, e.g., based on a capability of the devices; ii) data with a longer validity than the data in the second set of assistance data, iii) data to be provided at a lower frequency than data in the second set of assistance data, iv) data with a higher security sensitivity than data in the second set of assistance data, v) data for users with a higher priority than users of the data in the second set of assistance data, vi) data of interest to a lower number of devices in the wireless communications network 100 than the data in the second set of assistance data, vii) data to be provided in low load conditions of the wireless communications network 100, e.g., lower load conditions that those of the data in the second set of assistance data, viii) data to be provided with higher efficiency than via broadcast, e.g., broadcast transmission, ix) data to be provided with higher beamforming gain than with broadcast transmission, and x) data to be provided with better radio coverage than with broadcast transmission.

In effect, this may imply one or more of the following configuration combinations. According to a first configuration, the information may be separated into two categories, where the first category may be needed more seldom, and the second category may be needed more frequently, and the first category may be provided via broadcast and the second category may be provided via unicast. For example, a basic service may be provisioned with broadcasted assistance data every T1 seconds, and a professional service may be provisioned with unicasted assistance data every T2 seconds. In one example, the provisional service may be provided with information via unicast and broadcast, while the basic service may be provided only via broadcast.

According to a second configuration, the information may be separated into two or more types of validity time, where information with long validity time and that the second node 102 may need shortly after the request may be considered for unicast. One example may be the GNSS almanac data.

According to a third configuration, the information may be separated into device capabilities, where one capability may be supported by a large device population and the other capability may be supported by a small device population. One example may be support for satellite systems, where for example, GPS and GLONASS may be supported by a large population in a certain market, while GALILEO or BeiDou may be supported by a smaller population. Another example may be the more recent additions of advanced assistance data based on GNSS RTK, which may have a small support initially, while more traditional GNSS assistance data may have a large support. In this case, the information associated to the extensive device support may have broadcasted, while the information associated to the small device population may be unicasted.

In some examples, the first node 101 may have received a request for the assistance data from the second node 102, and the determining in this Action 305 may be in response to the request received from the second node 102.

By determining the first set of the assistance data to be provided to the second node 102 via unicast, and the second set of the assistance data to be provided to the second node 102 via broadcast in this Action 305, the first node 101 may be enabled to further better determine how to provide the assistance data to the wireless device 130, so that the wireless device 130 may be able to appropriately receive and handle the assistance data, according to the capability of the wireless device 130, the sensitivity of the assistance data, the priority of the assistance data, etc. . . . .

Action 306

In this Action 306, the first node 101 may initiate providing, to the second node 102, an indication indicating the first set of the assistance data to be provided to the second node 102 via unicast, and the second set of the assistance data to be provided to the second node 102 via broadcast.

Initiating may be understood as beginning, enabling or triggering. Initiating 306 providing in this Action may comprise providing, e.g., sending, or transmitting.

In some examples, the indication in this Action 306 may be referred to as a fourth indication. The fourth indication may be, for example, a signalling in the provide assistance information on the details of where each set of assistance data may be retrieved.

In some examples, the first node 101 may have received the request from the second node 102 on the assistance information and then the first node 101 may provide the indication on how this information may be retrieved, meaning which parts via unicast and which parts from broadcast.

By providing the fourth indication in this Action 306, the first node 101 may be enabled to further better determine how to provide the assistance data to the wireless device 130, so that the wireless device 130 may be able to appropriately receive and handle the assistance data.

Action 307

In this Action 306, the first node 101 provides, that is, sends 306, to at least one of: the second node 102 and the third node 103 operating in the wireless communications network 100, the first set of the assistance data via unicast, and the second set of the assistance data via broadcast.

In general, the method to send assistance data may be seen as a function of assistance data provisioning efficiency, network load, network capacity allocated to assistance data provisioning via unicast and broadcast, UE capability, UE subscription, type of assistance data, etc.

In some embodiments, wherein the third node 103 is the MME 115, the first node 101 may send the first set of the assistance data via unicast, to the second node 102 via the MME 115, that is, routed via the MME 115.

In some embodiments, wherein the third node 103 is a radio network node 110, the first node 101 may send the second set of the assistance data via broadcast, to the second node 102, via the radio network node 110.

With regards to the delivery of assistance data in this Action 307, the following may apply.

Using the unicast method, the LPP message ProvideAssistanceData may be used for unicast assistance data delivery.

Using the broadcast method, the following mechanism may be used for broadcast of assistance data delivery using LPPa between the first node 101 and the radio network node 110, and sending the broadcast information via SIB from the radio network node 110 to the second node 102.

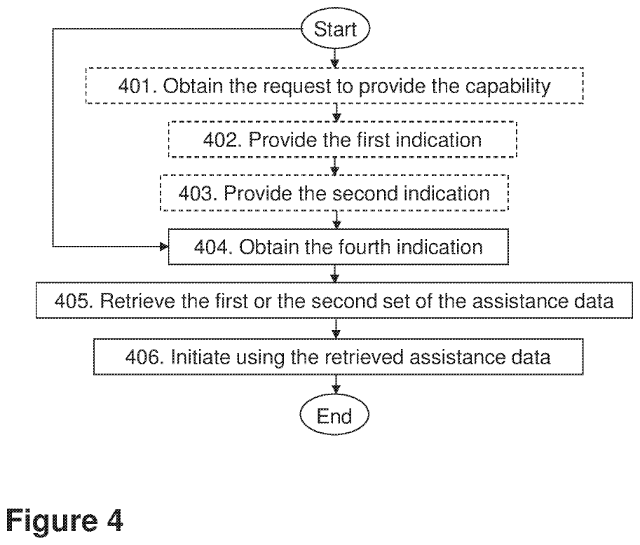

Embodiments of a method, performed by the second node 102, will now be described with reference to the flowchart depicted in FIG. 4. The method is for handling assistance data about the location of the second node 102. The second node 102 operates in the wireless communication network 100.

In some embodiments all the actions may be performed. In some embodiments, one or more actions may be optional. In FIG. 4, optional actions are indicated with dashed lines. It should be noted that the examples herein are not mutually exclusive. Several embodiments are comprised herein. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 4.

The detailed description of some of the following corresponds to the same references provided above, in relation to the actions described for the first node 101, and will thus not be repeated here to simplify the description, however, it applies equally. For example, the first node 101 may be the location server 105 and the second node 102 may be the wireless device 130.

Action 401

In this Action 401, the second node 102 may obtain the request from the first node 101 to provide the capability of the second node 102, the capability being about positioning.

Obtaining may be understood as receiving, for example, via the first link 141.

Action 402

In this Action 402, the second node 102 may provide, to the first node 101, the first indication indicating the capability the second node 102, the capability being about positioning.

The providing may be implemented, e.g., via the first link 141.

In some embodiments, the first indication may indicate whether the second node 102 supports detection of positioning broadcast information while in connected mode.

The one or more characteristics of the second node 102 may be indicated by the provided first indication.

In some embodiments, the providing in this Action 402 may be based on the obtained request in Action 401.

Action 403

In this Action 403, the second node 102 may provide, to the first node 101, the second indication indicating the scope of assistance data to be requested by the second node 102.

The one or more characteristics of the assistance data may be indicated by the provided second indication. In some examples, the scope of the assistance data may comprise at least one of: the type of the assistance data, the use the assistance data is requested for, and the method of positioning the assistance data is requested for.

Action 404

In this Action 404, the second node 102 may obtain, from the first node 101 operating in the wireless communications network 100, the indication about the first set of the assistance data to be provided via unicast, and the second set of the assistance data to be provided via broadcast. The obtaining in this Action 404 may be based on the one or more characteristics of at least one of: the second node 102, the assistance data, the wireless communications network 100, and the radio coverage of the second node 102, as described earlier.

In some examples, the first node 101 the indication may be referred to as a fourth indication.

In some examples the first set of assistance data be understood to be provided by the first node 101 to the second node 102 via unicast, and the second set of the assistance data to be provided by the first node 101 to the second node 102 via broadcast, via the third node 103, meaning that the assistance data may originate in the first node 101.

For example, at least one of the following options may apply. According to the first option, the one or more characteristics of the second node 102 may comprise the capability of the second node 102. According to the second option, the one or more characteristics of the assistance data may comprise at least one of: a) the information on the validity of the first set of the assistance data and the second set of the assistance data, and b) the interest on the first set of the assistance data and the second set of the assistance data. According to the third option, the one or more characteristics of the wireless communications network 100 may comprise at least one of: the load of the wireless communications network 100 and the efficiency of provisioning of the assistance data to the second node 102. According to the fourth option, the one or more characteristics of the radio coverage of the second node 102 may comprise one of: a) the potential beamforming gain of the unicast transmission or the broadcast transmission, and b) the radio condition information provided by the second node 102 in the request for the assistance data.

The second node 102 may have sent a request for the assistance data to the first node 101, and the obtaining 401 may be in response to the request sent by the second node 102. That is, the second node 102 may have sent the request on the assistance information to the first node 101, and then the first node 101 may provide the indication on how this information may be retrieved, meaning which parts via unicast and which parts from broadcast.

As will be described next, the second node 102 may perform some actions given the unicast/broadcast provisioning information.

When the second node 102 may have requested assistance data, it may receive a response message, e.g., comprising the fourth indication, from the first node 101. This message may comprise one or more of the following. In some examples, the fourth indication may comprise information about what is made available via broadcast. This may be, in a first example, a list of system information block numbers, where each number corresponds to a certain assistance data scope. In a second example, the information that may be made available via broadcast may comprise, a list of more descriptive information, which the second node 102, together with some retrieved broadcast information, may use to determine where to find the broadcasted information in the radio resources. In one mode, the descriptive information may be the type of assistance data, e.g., GNSS, OTDOA, the parts of a specific type, e.g., GNSS satellite systems, GNSS almanac, GNSS ephemeris, differential GNSS corrections, GNSS correction type such as RTK, RTK State space representation (SSR), RTK Virtual Reference Station (VRS), RTK Flachen Korrektur Parameter (FKP), RTK Master Auxiliary Concept (MAC), OTDOA signal information, OTDOA transmitter and timing information. In a third example, the information that may be made available via broadcast may comprise, anything that is not explicitly sent via unicast to the second node 102, that is, the second node 102 may conclude what may be sent via broadcast based on what has not been sent unicast. In a fourth example, the information that may be made available via broadcast may comprise nothing. In this example, the second node 102 may have done some initial work prior to any request from the first node 101 on the assistance information. In case the first node 101 may encrypt the broadcast information, then the second node 102 may be more specific in what additional assistance information it may require. The second node 102 may first determine what assistance data information that is available via broadcast, and then may request any additional assistance data information. In this case, the second node 102 may act according to the following steps. First. optionally, the second node 102 may request information about the broadcast encryption, Second, optionally, the second node 102 may obtain decryption information. Third, the second node 102 may retrieve the broadcasted assistance data. Fourth, based on the scope of the broadcasted assistance data, the second node 102 may determine what additional assistance data it may need. Fifth, the second node 102 may request the additional assistance data for unicast from the first node 101.

In a fifth example, the information that may be made available via broadcast may comprise information about the validity time of different parts of the assistance data. When the validity time of the assistance data provided via unicast expires, the second node 102 may request updated assistance data from the first node 101.

The second node 102 may be then retrieve, from the first node 101, at least one of the first set of the assistance data, via unicast, and the second set of the assistance data, via broadcast.

Action 405

In this Action 405, the second node 102 retrieves, from the first node 101 operating in the wireless communications network 100, the first set of the assistance data via unicast, and the second set of the assistance data via broadcast. The retrieving may be based on the one or more characteristics of at least one of: the second node 102, the assistance data, the wireless communications network 100, and the radio coverage of the second node 102. Retrieving may be understood as receiving, e.g., via the first link 141.

In some embodiments, the first set of the assistance data may comprise at least one of: i) the data supported by a lower number of devices in the wireless communications network 100 than the data in the second set of assistance data, e.g., based on a capability of the devices; ii) the data with the longer validity than the data in the second set of assistance data, iii) the data to be provided at the lower frequency than the data in the second set of assistance data, iv) the data with the higher security sensitivity than the data in the second set of assistance data, v) the data for the users with higher priority than the users of the data in the second set of assistance data, vi) the data of interest to a lower number of devices in the wireless communications network 100 than the data in the second set of assistance data, vii) the data to be provided in low load conditions of the wireless communications network 100, viii) the data to be provided with the higher efficiency than via broadcast, ix) the data to be provided with the higher beamforming gain than with broadcast transmission, and x) the data to be provided with better radio coverage than with broadcast transmission.

As stated earlier, in one embodiment, the second node 102 may have the capability of supporting retrieval of broadcasted positioning assistance data information in connected mode. Devices that are not capable of retrieving broadcasted positioning assistance data, may either obtain the positioning assistance data via either unicast or broadcast, or move between the connected and idle states in order to retrieve assistance data from unicast and broadcast.

Action 406

In this Action 406, the second node 102 may initiate using at least one of the retrieved first set of the assistance data and second set of the assistance data, to facilitate a positioning measurement.

Initiating may be understood as beginning, enabling or triggering. Initiating 302 performing may comprise sending, or transmitting.

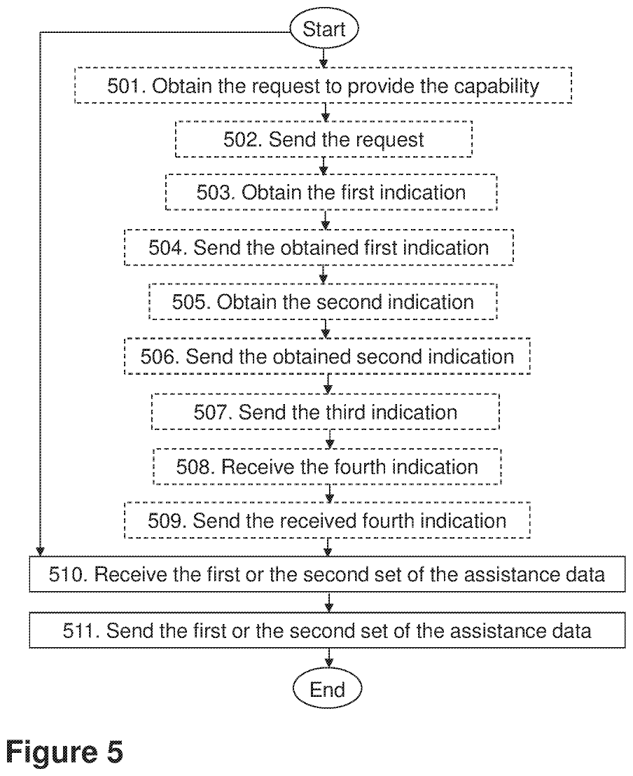

Embodiments of a method, performed by the radio network node 110, will now be described with reference to the flowchart depicted in FIG. 5. The method is for handling assistance data about the location of the second node 102. The radio network node 110 and the second node 102 operate in the wireless communication network 100.

In some embodiments all the actions may be performed. In some embodiments, one or more actions may be optional. In FIG. 5, optional actions are indicated with dashed lines. It should be noted that the examples herein are not mutually exclusive. Several embodiments are comprised herein. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 5.

The detailed description of some of the following corresponds to the same references provided above, in relation to the actions described for the first node 101, and will thus not be repeated here to simplify the description, however, it applies equally. For example, the first node 101 may be the location server 105 and the second node 102 may be the wireless device 130.

Action 501

In this Action 501, the radio network node 110 may obtain, from the first node 101, the request to the second node 102 to provide the capability of the second node 102, the capability being about positioning.

Obtaining may be understood as receiving, for example, via the second link 142.

Action 502

In this Action 502, the radio network node 110 may send the obtained request to the second node 102.

The sending may be implemented, e.g., via the fourth link 144.

Action 503

In this Action 503, the radio network node 110 may obtain, from the second node 102, the first indication indicating the capability the second node 102, the capability being about positioning.

In some embodiments, the one or more characteristics of the second node 102 may be indicated by the obtained first indication.

At least one of the following options may apply. According to the first option, the one or more characteristics of the second node 102 may comprise the capability of the second node 102. According to the second option, the one or more characteristics of the assistance data may comprise at least one of: a) the information on the validity of the first set of the assistance data and the second set of the assistance data, and b) the interest on the first set of the assistance data and the second set of the assistance data. According to the third option, the one or more characteristics of the wireless communications network 100 may comprise at least one of: the load of the wireless communications network 100 and the efficiency of provisioning of the assistance data to the second node 102. According to the fourth option, the one or more characteristics of the radio coverage of the second node 102 may comprise one of: a) the potential beamforming gain of the unicast transmission or the broadcast transmission, and b) the radio condition information provided by the second node 102 in the request for the assistance data.

In some embodiments, the obtaining in this Action 503 of the first indication may be based on the sent request in Action 502.

The first indication may indicate whether or not the second node 102 supports detection of positioning broadcast information while in connected mode.

The obtaining may be implemented, e.g., via the fourth link 144.

Action 504

In this Action 504, the radio network node 110 may send the obtained first indication to the first node 101, e.g., via the second link 142.

Action 505

In this Action 505, the radio network node 110 may obtain, from the second node 102, the second indication indicating the scope of assistance data to be requested by the second node 102.

As discussed earlier, the one or more characteristics of the assistance data may be indicated by the obtained second indication.

The obtaining may be implemented by receiving, e.g., via the fourth link 144.

Action 506

In this Action 506, the radio network node 110 may send the obtained second indication to the first node 101, e.g., via the second link 142.

Action 507

In this Action 507, the radio network node 110 may sending, to the first node 101, e.g., via the second link 142, at least the third indication indicating at least one of: the load of the wireless communications network 100 and the efficiency of provisioning of the assistance data to the second node 102.

The one or more characteristics of the wireless communications network 100 may be indicated by the sent third indication.

Action 508

In this Action 508, the radio network node 110 may receive, from the first node 101, e.g., via the second link 142, the indication indicating the first set of the assistance data to be provided to the second node 102 via unicast, and the second set of the assistance data to be provided to the second node 102 via broadcast.

That is, the radio network node 110 may receive the fourth indication.

Action 509

In this Action 509, the radio network node 110 may send the received fourth indication to the second node 102, e.g., via the fourth link 144.

Action 510

In this Action 510, the radio network node 110 receive, from the first node 101 operating in the wireless communications network 100, the first set of the assistance data to be provided to the second node 102 via unicast, and the second set of the assistance data to be provided to the second node 102 via broadcast. The receiving may be based on the one or more characteristics of at least one of: the second node 102, the assistance data, the wireless communications network 100, and the radio coverage of the second node 102. The receiving in this Action 510 may be, e.g., via the second link 142.

In some embodiments, based on the receiving in Action 510, the first set of the assistance data may comprise at least one of: i) the data supported by a lower number of devices in the wireless communications network 100 than the data in the second set of assistance data, e.g., based on a capability of the devices; ii) the data with the longer validity than the data in the second set of assistance data, iii) the data to be provided at the lower frequency than the data in the second set of assistance data, iv) the data with the higher security sensitivity than the data in the second set of assistance data, v) the data for the users with higher priority than the users of the data in the second set of assistance data, vi) the data of interest to a lower number of devices in the wireless communications network 100 than the data in the second set of assistance data, vii) the data to be provided in low load conditions of the wireless communications network 100, viii) the data to be provided with the higher efficiency than via broadcast, ix) the data to be provided with the higher beamforming gain than with broadcast transmission, and x) the data to be provided with better radio coverage than with broadcast transmission.

Action 511

In this Action 511, the radio network node 110 sends, to the second node 102, the first set of the assistance data via unicast, and the second set of the assistance data via broadcast. The sending in this Action 511 may be implemented, e.g., via the fourth link 144.

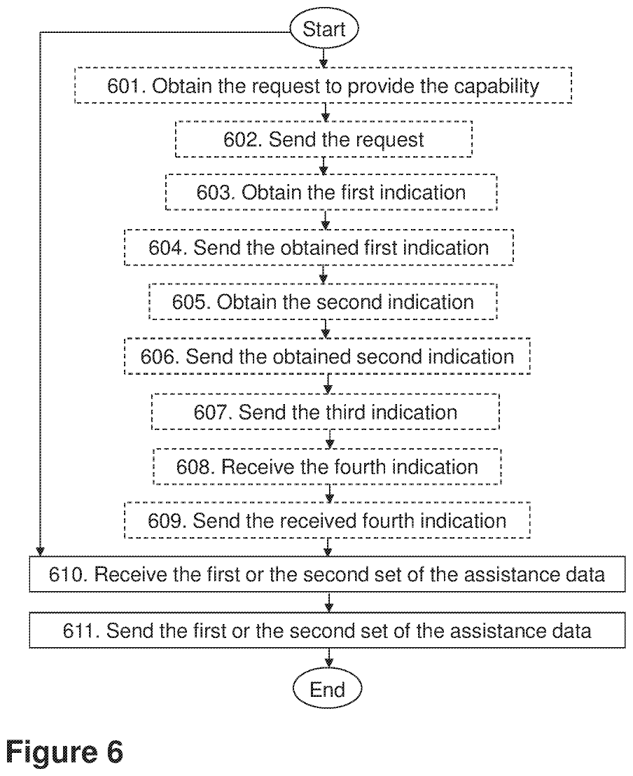

Embodiments of a method, performed by the mobility management entity 115, will now be described with reference to the flowchart depicted in FIG. 6. The method is for handling assistance data about the location of the second node 102. The mobility management entity 115 and the second node 102 operate in the wireless communication network 100.

In some embodiments all the actions may be performed. In some embodiments, one or more actions may be optional. In FIG. 6, optional actions are indicated with dashed lines. It should be noted that the examples herein are not mutually exclusive. Several embodiments are comprised herein. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 6.

The detailed description of some of the following corresponds to the same references provided above, in relation to the actions described for the first node 101, and will thus not be repeated here to simplify the description, however, it applies equally. For example, the first node 101 may be the location server 105 and the second node 102 may be the wireless device 130.

Action 601

In this Action 601, the mobility management entity 115 may obtain, from the first node 101, the request to the second node 102 to provide the capability of the second node 102, the capability being about positioning.

Obtaining may be understood as receiving, for example, via the third link 143.

Action 602

In this Action 602, the mobility management entity 115 may send the obtained request to the second node 102.

The sending may be implemented, e.g., via the fifth link 145 and the fourth link 144.

Action 603

In this Action 603, the mobility management entity 115 may obtain, from the second node 102, the first indication indicating the capability the second node 102, the capability being about positioning.

In some embodiments, the one or more characteristics of the second node 102 may be indicated by the obtained first indication.

The obtaining may be implemented, e.g., via the fourth link 144 and the fifth link 145.

At least one of the following options may apply. According to the first option, the one or more characteristics of the second node 102 may comprise the capability of the second node 102. According to the second option, the one or more characteristics of the assistance data may comprise at least one of: a) the information on the validity of the first set of the assistance data and the second set of the assistance data, and b) the interest on the first set of the assistance data and the second set of the assistance data. According to the third option, the one or more characteristics of the wireless communications network 100 may comprise at least one of: the load of the wireless communications network 100 and the efficiency of provisioning of the assistance data to the second node 102. According to the fourth option, the one or more characteristics of the radio coverage of the second node 102 may comprise one of: a) the potential beamforming gain of the unicast transmission or the broadcast transmission, and b) the radio condition information provided by the second node 102 in the request for the assistance data.

In some embodiments, the obtaining in this Action 603 of the first indication may be based on the sent request in Action 602.

The first indication may indicate whether or not the second node 102 supports detection of positioning broadcast information while in connected mode.

Action 604

In this Action 604, the mobility management entity 115 may send the obtained first indication to the first node 101, e.g., via the third link 143.

Action 605

In this Action 605, the mobility management entity 115 may obtain, from the second node 102, the second indication indicating the scope of assistance data to be requested by the second node 102.

As discussed earlier, the one or more characteristics of the assistance data may be indicated by the obtained second indication.

The obtaining may be implemented by receiving, e.g., via the fourth link 144 and the fifth link 145.

Action 606

In this Action 606, the mobility management entity 115 may send the obtained second indication to the first node 101, e.g., via the third link 143.

Action 607

In this Action 607, the mobility management entity 115 may sending, to the first node 101, e.g., via the third link 143, at least the third indication indicating at least one of: the load of the wireless communications network 100 and the efficiency of provisioning of the assistance data to the second node 102.

The one or more characteristics of the wireless communications network 100 may be indicated by the sent third indication.

Action 608

In this Action 608, the mobility management entity 115 may receive, from the first node 101, e.g., via the second link 142, the indication indicating the first set of the assistance data to be provided, e.g., by the radio network node 110, to the second node 102 via unicast, and the second set of the assistance data to be provided, e.g., by the radio network node 110, to the second node 102 via broadcast. That is, the mobility management entity 115 may receive the fourth indication.

Action 609

In this Action 609, the mobility management entity 115 may send the received fourth indication to the second node 102, e.g., via the fourth link 144 and the fifth indication 145.

Action 610

In this Action 610, the mobility management entity 115 receive, from the first node 101 operating in the wireless communications network 100, the first set of the assistance data to be provided, e.g., by the radio network node 110, to the second node 102 via unicast, and the second set of the assistance data to be provided, e.g., by the radio network node 110, to the second node 102 via broadcast. The receiving may be based on the one or more characteristics of at least one of: the second node 102, the assistance data, the wireless communications network 100, and the radio coverage of the second node 102. The receiving in this Action 610 may be, e.g., via the third link 143.

In some embodiments, based on the receiving in Action 610, the first set of the assistance data may comprise at least one of: i) the data supported by a lower number of devices in the wireless communications network 100 than the data in the second set of assistance data, e.g., based on a capability of the devices; ii) the data with the longer validity than the data in the second set of assistance data, iii) the data to be provided at the lower frequency than the data in the second set of assistance data, iv) the data with the higher security sensitivity than the data in the second set of assistance data, v) the data for the users with higher priority than the users of the data in the second set of assistance data, vi) the data of interest to a lower number of devices in the wireless communications network 100 than the data in the second set of assistance data, vii) the data to be provided in low load conditions of the wireless communications network 100, viii) the data to be provided with the higher efficiency than via broadcast, ix) the data to be provided with the higher beamforming gain than with broadcast transmission, and x) the data to be provided with better radio coverage than with broadcast transmission.

Action 611

In this Action 611, the mobility management entity 115 sends, to the second node 102, the first set of the assistance data via unicast, and the second set of the assistance data via broadcast. The sending in this Action 611 may be implemented via, for example, the radio network node 110, e.g., via the fourth link 144 and the fifth link 145.

In some embodiments, the mobility management entity 115 may send the first set of the assistance data, from the first node 101, via unicast, to the second node 102.

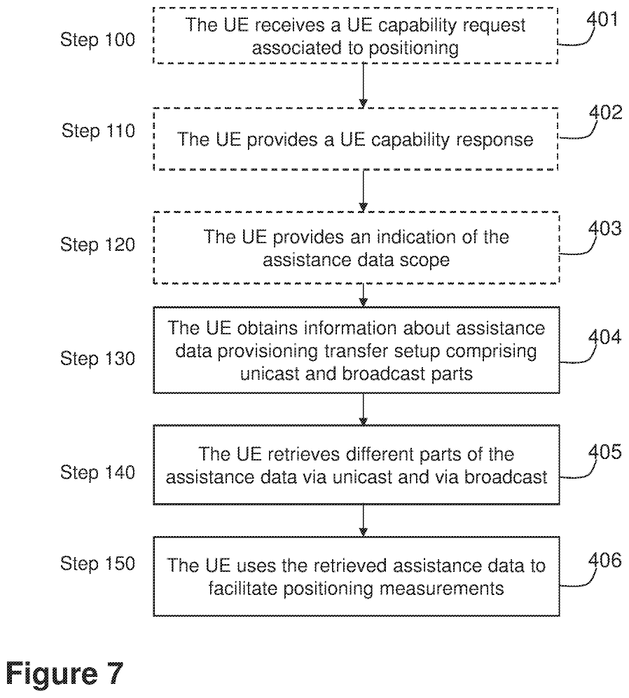

FIG. 7 is a schematic flowchart illustrating a non-limiting example of embodiments herein, from the perspective of the target device, that is, the second node 102, which in this example is the wireless device 130. The steps of FIG. 7 may be understood to be particular examples of the respective actions described above, as indicated by the pertinent reference number from FIG. 4. At step 100, in accordance with Action 401, the second node 102 optionally obtains from the first node 101, the location server 105 in this example, a UE capability request. At step 110, in accordance with Action 402, the second node 102 optionally provides to the first node 101 its capabilities associated to positioning. At step 120, in accordance with Action 403, also optionally, the second node 102 provides to the first node 101 an indication, that is, the second indication, of the assistance data scope, comprising what positioning methods assistance data is requested for, what types of positioning methods, what variants of the positioning methods, what types of assistance data, etc. At step 130, the second node 102 receives from the first node 101, in the fourth indication received in accordance with Action 404, information about what parts of the assistance data will be provided via broadcast, and what parts will be provided via unicast. At step 140, in accordance with Action 405, based on the provided information, the second node 102 retrieves the assistance data, where parts are retrieved via unicast and parts are retrieved via broadcast. At step 150, in accordance with Action 406, the second node 102 uses the retrieved assistance data to facilitate positioning measurements.

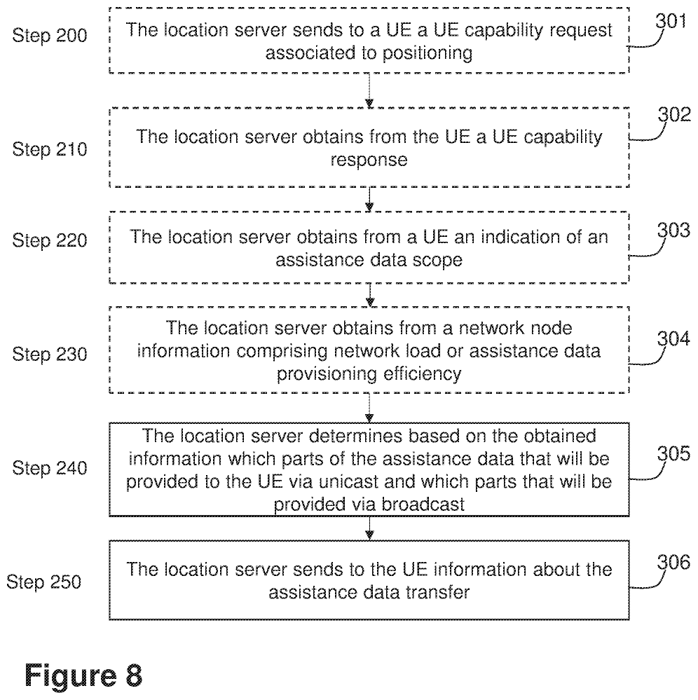

FIG. 8 is a schematic flowchart illustrating a non-limiting example of embodiments herein, from the perspective of the first node 101, in this example, the location server 105. The steps of FIG. 8 may be understood to be particular examples of the respective actions described below, as indicated by the pertinent reference number from FIG. 3. At step 200, in accordance with Action 301, the first node 101 optionally requests UE capabilities from a target device such as the second node 102. At step 210, in accordance with Action 302, the first node 101 optionally obtains from the second node 102 its capabilities associated to positioning. Also optionally, at step 220, in the second indication in accordance with Action 303, the first node 101 obtains from the second node 102 an indication of the assistance data scope, comprising what positioning methods assistance data is requested for, what types of positioning methods, what variants of the positioning methods, what types of assistance data, etc. In addition, At step 230, in the third indication in accordance with Action 304, the first node 101 may obtain information from a network node such as the third network node 103, e.g., the MM entity 115 or a radio base station such as the radio network node 110, about the network load or assistance data efficiency. At step 240, in accordance with Action 305, the first node 101 determines, based on the obtained information, which parts of the assistance data that will be provided to the second node 102, e.g., a UE, via unicast and which parts that will be provided via broadcast. Once determined, at step 250, in accordance with Action 305, the first node 101 sends information to the second node 102 about how to retrieve the assistance data. Then, and in accordance with Action 307, which is not represented in FIG. 8, the first node 101, sends the first set of the assistance data via unicast, and the second set of the assistance data via broadcast to the second node 102.

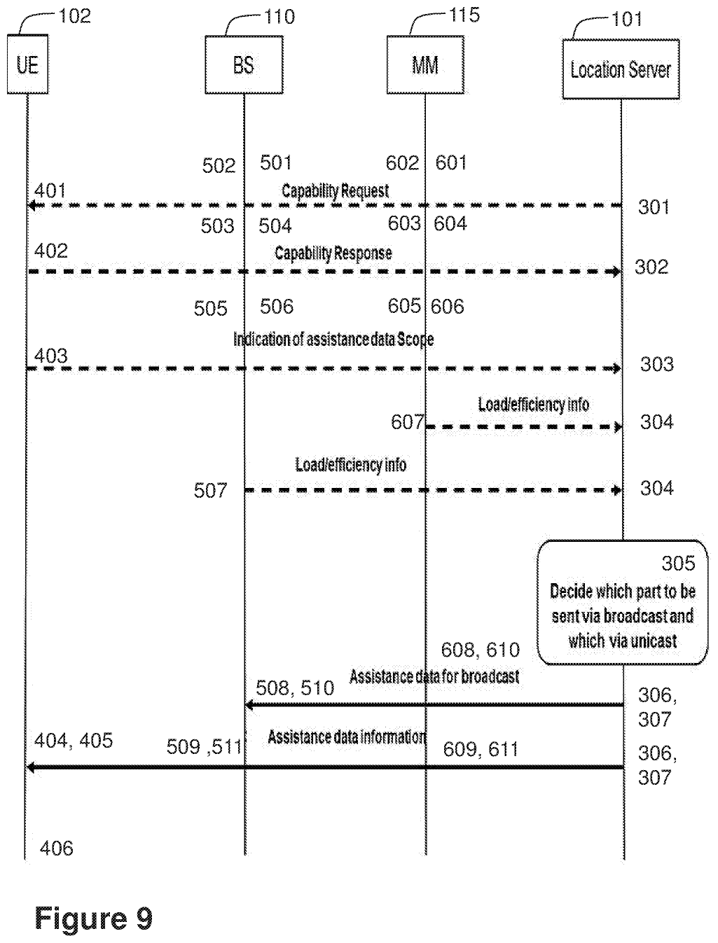

FIG. 9 depicts a non-limiting example of a signalling chart with selected actions of the embodiments herein. In the example of FIG. 9, the first node 101 is the location server 105, the second node 102 is a UE, the radio network node 110 is a base station (BS) and the mobility management entity 115 is an MME. The second node 102 optionally obtains, at Action 401, from the first node 101 a UE capability request, and the second node 102 optionally provides, at Action 402, to the first node 101 its capabilities associated to positioning. Also optionally, the second node 102 provides, at Action 403, to the first node 101 an indication, that is, the second indication, of the assistance data scope, comprising what positioning methods assistance data is requested for, what types of positioning methods, what variants of the positioning methods, what types of assistance data, etc. Moreover, the first node 101 may also obtain information about the network load and efficiency information from network nodes, such as the radio network node 110, according to Action 304. This may comprise obtaining information from the mobility management entity, sent at Action 607, and from the radio network node 110, sent at Action 507. The first node 101 determines, according to Action 305, based on the obtained information, which parts of the assistance data that are or will be provided to the UE via unicast and which parts that are or will be provided via broadcast. The broadcast information is provided, according to Action 307, by the first node 101 to the radio network node 110. Once determined, the first node 101 sends, according to Action 306, information to the second node 102 about how to retrieve the assistance data. The information also may include the unicast of the assistance data itself, according to Action 307. The second node 102 receives, according to Action 405, from the first node 101 information about what parts of the assistance data that will be provided via broadcast and what parts that will be provided via unicast. Based on the provided information, the second node 102 retrieves, according to Action 405, the assistance data, where parts are retrieved via unicast and parts are retrieved via broadcast. The second node 102 then uses, according to Action 406, the retrieved assistance data to facilitate positioning measurements.

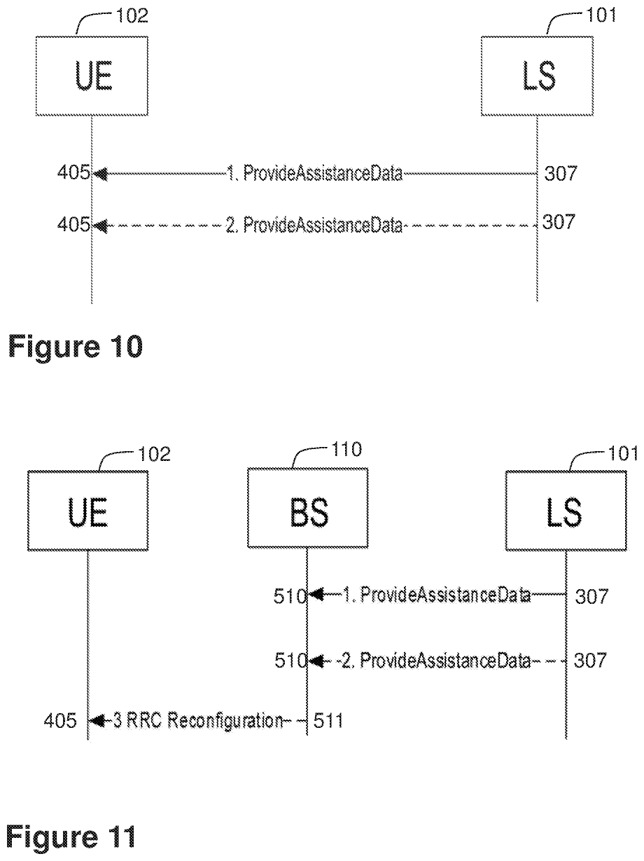

FIG. 10 is a schematic diagram illustrating a non-limiting example of unicast assistance data provisioning, between the first node 101, e.g., the LS 105, the second node 102, here a UE. The LPP message ProvideAssistanceData can be used for unicast assistance data delivery. The reference numbers used correspond to the actions described in FIGS. 3-4.

FIG. 11 is a schematic diagram illustrating a non-limiting example of unicast assistance data provisioning via the radio network node 110, here a base station, in accordance with Action 307. In this example, the assistance provisioning is implemented using LPPa messages between the first node 101, e.g., the LS 105, and the third node 103, here the radio network node 110, e.g., a BS. The RRC between the radio network node 110 and the second node 102, here a UE may then be used for providing the assistance data from the first node 101 to the second node 102 via the radio network node 110. The reference numbers used correspond to the actions described in FIGS. 3-5.

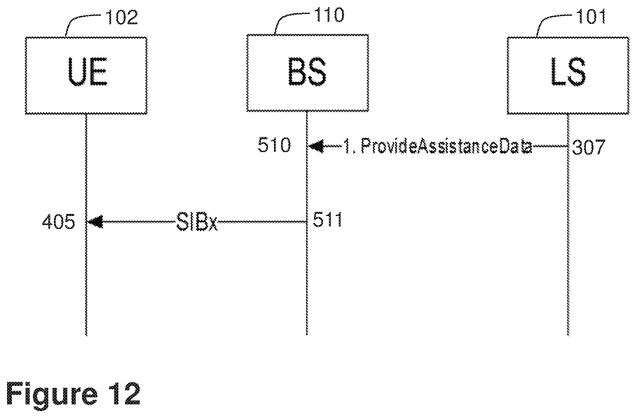

FIG. 12 is a schematic diagram illustrating a non-limiting example of broadcast assistance data provisioning via system information from the radio network node 110, a base station in this example. LPPa may be used between the first node 101 and the radio network node 110, and then the radio network node 110 may send the broadcast information via SIB, a SIB transmission represented as SIBx, to the second node 102. The reference numbers used correspond to the actions described in FIGS. 3-5.

Certain embodiments may provide one or more of the following technical advantage(s). The advantages of the embodiments herein are mainly in terms of efficiency and flexibility which may be summarized as follows. Information which may be common to a group of devices, e.g., comprising the second node 102, may be shared via broadcast. Information which may be dedicated to a user may be transmitted via unicast. Information which may be more security sensitive such as security key etc. . . . may be transmitted via dedicate signalling, that is, unicast. To a high priority user, such as an emergency public services user, a Business or Gold customer, an opportunity is provided to do a unicast transmission. Information that seldom needs to be updated may be only sent upon request via unicast. Depending upon the network load, a decision may be made on what proportion may need to be used for unicast and what proportion for broadcast.

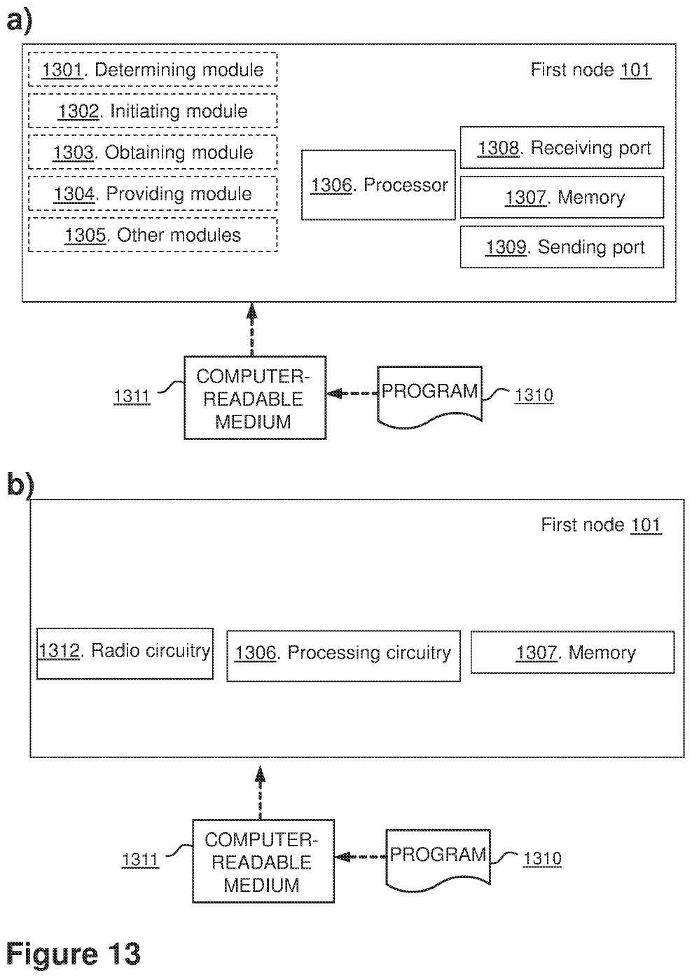

FIG. 13 depicts two different examples in panels a) and b), respectively, of the arrangement that the first node 101 may comprise to perform the method actions described above in relation to FIG. 3. In some embodiments, the first node 101 may comprise the following arrangement depicted in FIG. 13a. The first node 101 is configured to handle assistance data about the location of the second node 102. The first node 101 and the second node 102 are further configured to operate in a wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 101, and will thus not be repeated here. For example, the first node 101 may be the location server 105 and the second node 102 may be the wireless device 130. In FIG. 13, optional modules are indicated with dashed boxes.

The first node 101 is configured to perform the determining of action 305, e.g. by means of a determining module 1301 within the first node 101, configured to determine the first set of the assistance data to be provided to the second node 102 via unicast, and the second set of the assistance data to be provided to the second node 102 via broadcast, wherein to determine is configured to be based on the one or more characteristics of at least one of: the second node 102, the assistance data, the wireless communications network 100, and the radio coverage of the second node 102. The determining module 1301 may be a processor 1306 of the first node 101, or an application running on such processor.

In some embodiments, at least one of the following may apply: a) the one or more characteristics of the second node 102 may comprise the capability of the second node 102; b) the one or more characteristics of the assistance data may comprise at least one of: i) information on the validity of the first set of the assistance data and second set of the assistance data, and ii) an interest on the first set of the assistance data and second set of the assistance data; c) the one or more characteristics of the wireless communications network 100 may comprise at least one of: i) the load of the wireless communications network 100 and the efficiency of provisioning of the assistance data to the second node 102; and d) the one or more characteristics of the radio coverage of the second node 102 may comprise one of: i) the potential beamforming gain of the unicast transmission or the broadcast transmission, and ii) the radio condition information configured to be provided by the second node 102 in the request for the assistance data.

In some embodiments, based on the determination, the first set of the assistance data may be configured to comprise at least one of: i) data supported by a lower number of devices in the wireless communications network 100 than the data in the second set of assistance data; ii) data with a longer validity than the data in the second set of assistance data, iii) data to be provided at a lower frequency than data in the second set of assistance data, iv) data with a higher security sensitivity than data in the second set of assistance data, v) data for users with a higher priority than users of the data in the second set of assistance data, vi) data of interest to a lower number of devices in the wireless communications network 100 than the data in the second set of assistance data, vii) data to be provided in low load conditions of the wireless communications network 100, viii) data to be provided with higher efficiency than via broadcast, ix) data to be provided with higher beamforming gain than with broadcast transmission, and x) data to be provided with better radio coverage than with broadcast transmission.

The first node 101 is configured to perform the sending of action 307, e.g. by means of an initiating module 1302 within the first node 101 configured to send, to at least one of: the second node 102 and the third node 103 configured to operate in the wireless communications network 100, the first set of the assistance data via unicast, and the second set of the assistance data via broadcast. The initiating module 1302 may be the processor 1306 of the first node 101, or an application running on such processor.

The first node 101 may be configured to perform the initiating providing of action 306, e.g. by means of the initiating module 1302 within the first node 101 configured to initiate providing, to the second node 102, the indication configured to indicate the first set of the assistance data to be provided to the second node 102 via unicast, and the second set of the assistance data to be provided to the second node 102 via broadcast. The initiating module 1302 may be the processor 1306 of the first node 101, or an application running on such processor.

The first node 101 may be further configured to perform the obtaining of action 302, e.g. by means of an obtaining module 1303 within the first node 101, configured to obtain, from the second node 102, the first indication configured to indicate the capability the second node 102, the capability being about positioning. The one or more characteristics of the second node 102 may be configured to be indicated by the first indication configured to be obtained. The obtaining module 1303 may be the processor 1306 of the first node 101, or an application running on such processor.

The first node 101 may be configured to perform the providing of action 301, e.g. by means of a providing module 1304 within the first node 101, configured to provide the request to the second node 102 to provide the capability of the second node 102, the capability being about positioning. The obtaining 302 the first indication may be based on the request configured to be provided. The providing module 1304 may be the processor 1306 of the first node 101, or an application running on such processor.

In some embodiments, the first indication may be configured to indicate whether or not the second node 102 supports detection of positioning broadcast information while in connected mode.

The first node 101 may be configured to perform the obtaining of action 303, 220, e.g. by means of the obtaining module 1303 within the first node 101, further configured to obtain, from the second node 102, the second indication configured to indicate the scope of assistance data to be requested by the second node 102. The one or more characteristics of the assistance data may be configured to be indicated by the second indication configured to be obtained.

The first node 101 may be configured to perform the determining of action 304, e.g. by means of the obtaining module 1303 within the first node 101, further configured to obtain, from the third node 103, at least the third indication configured to indicate at least one of: the load of the wireless communications network 100 and the efficiency of provisioning of the assistance data to the second node 102, and wherein the one or more characteristics of the wireless communications network 100 are configured to be indicated by the obtained third indication.

In some embodiments, wherein the third node 103 is a radio network node 110, the first node 101 may be configured to send the second set of the assistance data via broadcast, to the second node 102 via the radio network node 110.

In some embodiments, wherein the third node 103 is the mobility management entity 115, the first node 101 may be configured to send the first set of the assistance data via unicast, to the second node 102 via the mobility management entity 115.

Other modules 1305 may be comprised in the first node 101.

The embodiments herein in the first node 101 may be implemented through one or more processors, such as a processor 1306 in the first node 101 depicted in FIG. 13a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 1307 comprising one or more memory units. The memory 1307 is arranged to be used to store obtained information, store data, configurations, schedulings, and applications etc. to perform the methods herein when being executed in the first node 101.

In some embodiments, the first node 101 may receive information from, e.g., the second node 102, the radio network node 110 or the mobility management entity 115, through a receiving port 1308. In some embodiments, the receiving port 1308 may be, for example, connected to one or more antennas in first node 101. In other embodiments, the first node 101 may receive information from another structure in the wireless communications network 100 through the receiving port 1308. Since the receiving port 1308 may be in communication with the processor 1306, the receiving port 1308 may then send the received information to the processor 1306. The receiving port 1308 may also be configured to receive other information.

The processor 1306 in the first node 101 may be further configured to transmit or send information to e.g., the second node 102, the radio network node 110 or the mobility management entity 115, or another structure in the wireless communications network 100, through a sending port 1309, which may be in communication with the processor 1306, and the memory 1307.

Those skilled in the art will also appreciate that the determining module 1301, the initiating module 1302, the obtaining module 1303, the providing module 1304 and the other modules 1305 described above may refer to a combination of analog and digital modules, and/or one or more processors configured with software and/or firmware, e.g., stored in memory, that, when executed by the one or more processors such as the processor 1306, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1301-1305 described above may be implemented as one or more applications running on one or more processors such as the processor 1306.

Thus, the methods according to the embodiments described herein for the first node 101 may be respectively implemented by means of a computer program 1310 product, comprising instructions, i.e., software code portions, which, when executed on at least one processor 1306, cause the at least one processor 1306 to carry out the actions described herein, as performed by the first node 101. The computer program 1310 product may be stored on a computer-readable storage medium 1311. The computer-readable storage medium 1311, having stored thereon the computer program 1310, may comprise instructions which, when executed on at least one processor 1306, cause the at least one processor 1306 to carry out the actions described herein, as performed by the first node 101. In some embodiments, the computer-readable storage medium 1313 may be a non-transitory computer-readable storage medium, such as a CD ROM disc, or a memory stick. In other embodiments, the computer program 1310 product may be stored on a carrier containing the computer program 1310 just described, wherein the carrier is one of an electronic signal, optical signal, radio signal, or the computer-readable storage medium 1311, as described above.

The first node 101 may comprise an interface unit to facilitate communications between the first node 101 and other nodes or devices, e.g., the second node 102, or any of the other nodes. In some particular examples, the interface may, for example, include a transceiver configured to transmit and receive radio signals over an air interface in accordance with a suitable standard.

In other embodiments, the first node 101 may comprise the following arrangement depicted in FIG. 13b. The first node 101 may comprise a processing circuitry 1306, e.g., one or more processors such as the processor 1306, in the first node 101 and the memory 1307. The first node 101 may also comprise a radio circuitry 1312, which may comprise e.g., the receiving port 1308 and the sending port 1309. The processing circuitry 1306 may be configured to, or operable to, perform the method actions according to FIG. 3, FIG. 8, FIG. 9, FIG. 10, FIG. 11, and/or FIG. 12, in a similar manner as that described in relation to FIG. 13a. The radio circuitry 1312 may be configured to set up and maintain at least a wireless connection with the second node 102. Circuitry may be understood herein as a hardware component.

Hence, embodiments herein also relate to the first node 101 operative to handle assistance data about the location of the second node 102, the first node 101 being operative to operate in the wireless communications network 100. The first node 101 may comprise the processing circuitry 1306 and the memory 1307, said memory 1307 containing instructions executable by said processing circuitry 1306, whereby the first node 101 is further operative to perform the actions described herein in relation to the first node 101, e.g., in FIG. 3, FIG. 8, FIG. 9, FIG. 10, FIG. 11, and/or FIG. 12.

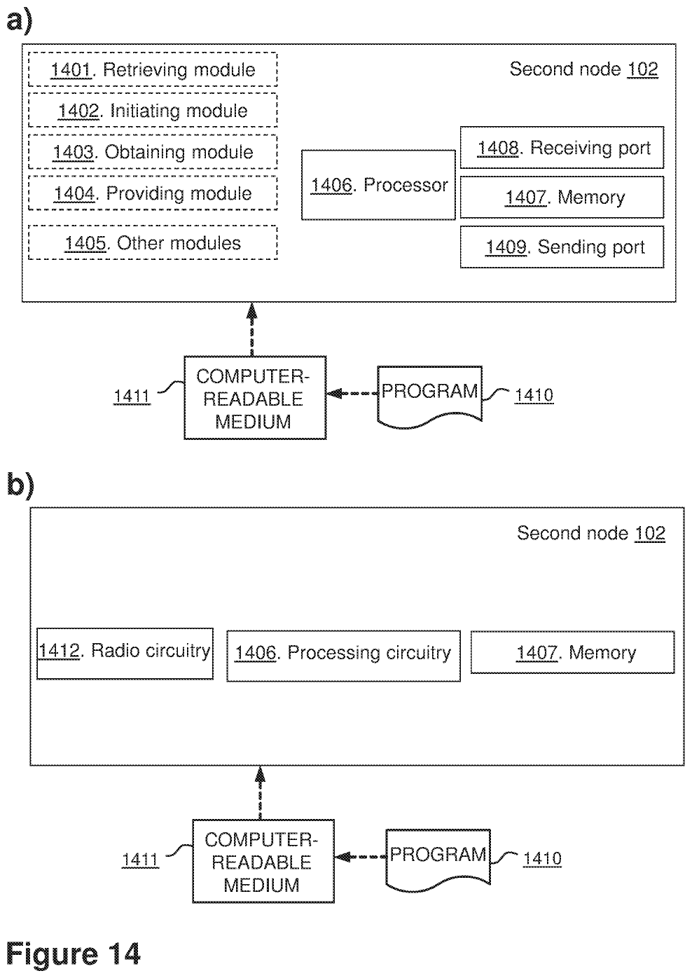

FIG. 14 depicts two different examples in panels a) and b), respectively, of the arrangement that the second node 102 may comprise to perform the method actions described above in relation to FIG. 4. In some embodiments, the second node 102 may comprise the following arrangement depicted in FIG. 14a. The second node 102 is configured to handle assistance data about the location of the second node 102. The second node 102 is further configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 102, and will thus not be repeated here. For example, the first node 101 may be the location server 105 and the second node 102 may be the wireless device 130.

In FIG. 14, optional modules are indicated with dashed boxes.

The second node 102 is configured to perform the retrieving of Action 405, e.g. by means of a retrieving module 1401 within the second node 102, configured to retrieve, from the first node 101 configured to operate in the wireless communications network 100, the first set of the assistance data via unicast, and the second set of the assistance data via broadcast. To retrieve is configured to be based on the one or more characteristics of at least one of: the second node 102, the assistance data, the wireless communications network 100, and the radio coverage of the second node 102. The retrieving module 1401 may be the processor 1406 of the second node 102, or an application running on such processor.

The second node 102 is configured to perform the initiating of Action 406, e.g. by means of an Initiating module 1402 within the second node 102, configured to initiate using at least one of the first set of the assistance data and second set of the assistance data configured to be retrieved, to facilitate the positioning measurement. The initiating module 1402 may be the processor 1406 of the second node 102, or an application running on such processor.

The second node 102 may be configured to perform the obtaining of Action 401, e.g. by means of an obtaining module 1403 within the second node 102, configured to obtain, from the first node 101, the indication about the first set of the assistance data to be provided via unicast, and the second set of the assistance data to be provided via broadcast To obtain may be configured to be based on the one or more characteristics of at least one of: the second node 102, the assistance data, the wireless communications network 100, and the radio coverage of the second node 102. The obtaining module 1403 may be a processor 1406 of the second node 102, or an application running on such processor.

In some embodiments, at least one of the following may apply: a) the one or more characteristics of the second node 102 may comprise the capability of the second node 102; b) the one or more characteristics of the assistance data may comprise at least one of: i) information on the validity of the first set of the assistance data and second set of the assistance data, and ii) an interest on the first set of the assistance data and second set of the assistance data; c) the one or more characteristics of the wireless communications network 100 may comprise at least one of: i) the load of the wireless communications network 100 and the efficiency of provisioning of the assistance data to the second node 102; and d) the one or more characteristics of the radio coverage of the second node 102 may comprise one of: i) the potential beamforming gain of the unicast transmission or the broadcast transmission, and ii) the radio condition information configured to be provided by the second node 102 in the request for the assistance data.

In some embodiments, based on the determination, the first set of the assistance data may be configured to comprise at least one of: i) data supported by a lower number of devices in the wireless communications network 100 than the data in the second set of assistance data; ii) data with a longer validity than the data in the second set of assistance data, iii) data to be provided at a lower frequency than data in the second set of assistance data, iv) data with a higher security sensitivity than data in the second set of assistance data, v) data for users with a higher priority than users of the data in the second set of assistance data, vi) data of interest to a lower number of devices in the wireless communications network 100 than the data in the second set of assistance data, vii) data to be provided in low load conditions of the wireless communications network 100, viii) data to be provided with higher efficiency than via broadcast, ix) data to be provided with higher beamforming gain than with broadcast transmission, and x) data to be provided with better radio coverage than with broadcast transmission.

The second node 102 may be further configured to perform the providing of Action 402, e.g. by means of a providing module 1404 within the second node 102, configured to provide, to the first node 101, the first indication configured to indicate the capability the second node 102, the capability being about positioning. The one or more characteristics of the second node 102 may be configured to be indicated by the provided first indication. The providing module 1404 may be the processor 1406 of the second node 102, or an application running on such processor.

The second node 102 may be further configured to perform the obtaining of Action 401, e.g. by means of the obtaining module 1401 within the second node 102, configured to obtain the request from the first node 101 to provide the capability of the second node 102, the capability being about positioning. To provide may be based on the request configured to be obtained.

In some embodiments, the first indication may be configured to indicate whether the second node 102 supports detection of positioning broadcast information while in connected mode.

The second node 102 may be further configured to perform the providing of Action 403, e.g. by means of the providing module 1404 within the second node 102, configured to provide, to the first node 101, the second indication configured to indicate the scope of assistance data configured to be requested by the second node 102. The one or more characteristics of the assistance data may be configured to be indicated by the second indication configured to be provided.

Other modules 1405 may be comprised in the second node 102.

The embodiments herein in the second node 102 may be implemented through one or more processors, such as a processor 1406 in the second node 102 depicted in FIG. 14a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 102. One such carrier may be in the form of a CD ROM disc. It is however feasible with other data carriers such as a memory stick. The computer program code may furthermore be provided as pure program code on a server and downloaded to the second node 102.

The second node 102 may further comprise a memory 1407 comprising one or more memory units. The memory 1407 is arranged to be used to store obtained information, store data, configurations, schedulings, and applications etc. to perform the methods herein when being executed in the second node 102.

In some embodiments, the second node 102 may receive information from, e.g., the first node 101, the radio network node 110 or the mobility management entity 115, through a receiving port 1408. In some embodiments, the receiving port 1408 may be, for example, connected to one or more antennas in second node 102. In other embodiments, the second node 102 may receive information from another structure in the wireless communications network 100 through the receiving port 1408. Since the receiving port 1408 may be in communication with the processor 1406, the receiving port 1408 may then send the received information to the processor 1406. The receiving port 1408 may also be configured to receive other information.

The processor 1406 in the second node 102 may be further configured to transmit or send information to e.g., the first node 101, the radio network node 110 or the mobility management entity 115, or another structure in the wireless communications network 100, through a sending port 1409, which may be in communication with the processor 1406, and the memory 1407.

Those skilled in the art will also appreciate that the retrieving module 1401, the initiating module 1402, the obtaining module 1403, the providing module 1404, and the other modules 1405 described above may refer to a combination of analog and digital modules, and/or one or more processors configured with software and/or firmware, e.g., stored in memory, that, when executed by the one or more processors such as the processor 1406, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1401-1405 described above may be implemented as one or more applications running on one or more processors such as the processor 1406.

Thus, the methods according to the embodiments described herein for the second node 102 may be respectively implemented by means of a computer program 1410 product, comprising instructions, i.e., software code portions, which, when executed on at least one processor 1406, cause the at least one processor 1406 to carry out the actions described herein, as performed by the second node 102. The computer program 1410 product may be stored on a computer-readable storage medium 1411. The computer-readable storage medium 1411, having stored thereon the computer program 1410, may comprise instructions which, when executed on at least one processor 1406, cause the at least one processor 1406 to carry out the actions described herein, as performed by the second node 102. In some embodiments, the computer-readable storage medium 1411 may be a non-transitory computer-readable storage medium, such as a CD ROM disc, or a memory stick. In other embodiments, the computer program 1410 product may be stored on a carrier containing the computer program 1410 just described, wherein the carrier is one of an electronic signal, optical signal, radio signal, or the computer-readable storage medium 1411, as described above.

The second node 102 may comprise a communication interface configured to facilitate communications between the second node 102 and other nodes or devices, e.g., the first node 101. The interface may, for example, include a transceiver configured to transmit and receive radio signals over an air interface in accordance with a suitable standard.

In other embodiments, the second node 102 may comprise the following arrangement depicted in FIG. 14b. The second node 102 may comprise a processing circuitry 1406, e.g., one or more processors such as the processor 1406, in the second node 102 and the memory 1407. The second node 102 may also comprise a radio circuitry 1412, which may comprise e.g., the receiving port 1408 and the sending port 1409. The processing circuitry 1406 may be configured to, or operable to, perform the method actions according to FIG. 4, FIG. 7, FIG. 9, FIG. 10, FIG. 11, and/or FIG. 12, in a similar manner as that described in relation to FIG. 14a. The radio circuitry 1412 may be configured to set up and maintain at least a wireless connection with the first node 101. Circuitry may be understood herein as a hardware component.

Hence, embodiments herein also relate to the second node 102 operative to handle assistance data about the location of the second node 102, the second node 102 being operative to operate in the wireless communications network 100. The second node 102 may comprise the processing circuitry 1406 and the memory 1407, said memory 1407 containing instructions executable by said processing circuitry 1406, whereby the second node 102 is further operative to perform the actions described herein in relation to the second node 102, e.g., in FIG. 4. FIG. 7, FIG. 9, FIG. 10, FIG. 11, and/or FIG. 12.

The apparatus illustrated in FIG. 14 may be understood to describe a target device, such as the second node 102, arranged with the radio circuitry 1412 to communicate with a serving BSs, such as the radio network node 110, and to detect and measure configured positioning reference signals, memory to store information related to the embodiments herein, and a processing unit. The radio circuitry 1412 may be configured to receive assistance data information for positioning. The radio circuitry 1412 may be configured to receive capability requests and send capability responses. It may be configured to send an assistance data request, and may be configured to receive assistance data. The assistance data may selectively be received via unicast and/or broadcast. The radio circuitry 1412 may also be configured to send positioning measurements and/or positioning estimates from other base stations. The processing unit, e.g., the processing circuitry 1406, may be configured to determine which assistance data information that is being made available via unicast and via broadcast respectively. The memory may be configured to store assistance data information and possibly also positioning measurements.

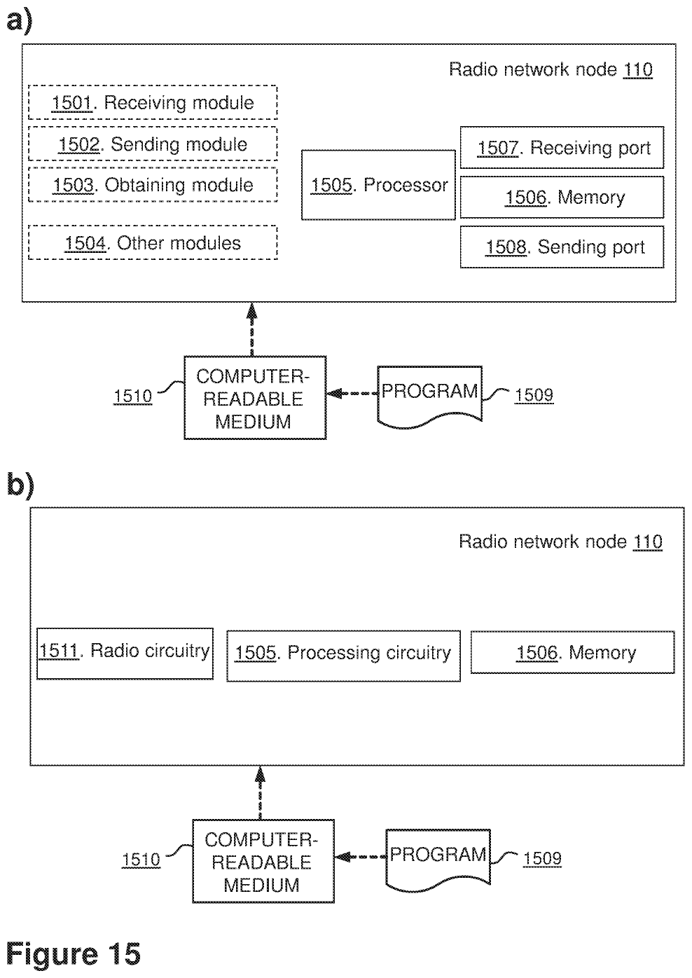

FIG. 15 depicts two different examples in panels a) and b), respectively, of the arrangement that the radio network node 110 may comprise to perform the method actions described above in relation to FIG. 5. In some embodiments, the radio network node 110 may comprise the following arrangement depicted in FIG. 15a. The radio network node 110 is configured to handle assistance data about the location of the radio network node 110. The radio network node 110 and the second node 102 are further configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the radio network node 110, and will thus not be repeated here. For example, the first node 101 may be the location server 105 and the radio network node 110 may be the wireless device 130.

In FIG. 15, optional modules are indicated with dashed boxes.

The radio network node 110 is configured to perform the receiving of Action 510, e.g. by means of a receiving module 1501 within the radio network node 110, configured to receive, from the first node 101 configured to operate in the wireless communications network 100 the first set of the assistance data to be provided to the second node 102 via unicast, and the second set of the assistance data to be provided to the second node 102 via broadcast. To receive is configured to be based on the one or more characteristics of at least one of: the second node 102, the assistance data, the wireless communications network 100, and the radio coverage of the second node 102. The receiving module 1501 may be a processor 1505 of the radio network node 110, or an application running on such processor.

The radio network node 110 is configured to perform the sending of Action 511, e.g. by means of a sending module 1502 within the radio network node 110, configured to send, to the second node 102, the first set of the assistance data via unicast, and the second set of the assistance data via broadcast. The sending module 1502 may be the processor 1505 of the radio network node 110, or an application running on such processor.

The radio network node 110 may be further configured to perform the receiving of Action 508, e.g. by means of the receiving module 1501 within the radio network node 110, configured to receive, from the first node 101, the indication configured to indicate the first set of the assistance data to be provided to the second node 102 via unicast, and the second set of the assistance data to be provided to the second node 102 via broadcast.

The radio network node 110 may be further configured to perform the sending of Action 509, e.g. by means of the sending module 1502 within the radio network node 110, configured to send the indication configured to be received, to the second node 102.

In some embodiments, at least one of the following may apply: a) the one or more characteristics of the radio network node 110 may comprise the capability of the radio network node 110; b) the one or more characteristics of the assistance data may comprise at least one of: i) information on the validity of the first set of the assistance data and second set of the assistance data, and ii) an interest on the first set of the assistance data and second set of the assistance data; c) the one or more characteristics of the wireless communications network 100 may comprise at least one of: i) the load of the wireless communications network 100 and the efficiency of provisioning of the assistance data to the radio network node 110; and d) the one or more characteristics of the radio coverage of the radio network node 110 may comprise one of: i) the potential beamforming gain of the unicast transmission or the broadcast transmission, and ii) the radio condition information configured to be provided by the radio network node 110 in the request for the assistance data.

In some embodiments, based on the determination, the first set of the assistance data may be configured to comprise at least one of: i) data supported by a lower number of devices in the wireless communications network 100 than the data in the second set of assistance data; ii) data with a longer validity than the data in the second set of assistance data, iii) data to be provided at a lower frequency than data in the second set of assistance data, iv) data with a higher security sensitivity than data in the second set of assistance data, v) data for users with a higher priority than users of the data in the second set of assistance data, vi) data of interest to a lower number of devices in the wireless communications network 100 than the data in the second set of assistance data, vii) data to be provided in low load conditions of the wireless communications network 100, viii) data to be provided with higher efficiency than via broadcast, ix) data to be provided with higher beamforming gain than with broadcast transmission, and x) data to be provided with better radio coverage than with broadcast transmission.

The radio network node 110 may be further configured to perform the obtaining of Action 503, e.g. by means of an obtaining module 1503 within the radio network node 110, configured to obtain, from the second node 102, the first indication configured to indicate the capability the second node 102, the capability being about positioning. The one or more characteristics of the second node 102 may be configured to be indicated by the obtained first indication. The obtaining module 1503 may be a processor 1505 of the radio network node 110, or an application running on such processor.

The radio network node 110 may be further configured to perform the sending of Action 504, e.g. by means of the sending module 1502 within the radio network node 110, configured to send the obtained first indication to the first node 101.

The radio network node 110 may be further configured to perform the obtaining of Action 501, e.g. by means of the obtaining module 1503 within the radio network node 110, configured to obtain, from the first node 101, the request to the second node 102 to provide the capability of the second node 102, the capability being about positioning.

The radio network node 110 may be further configured to perform the sending of Action 502, e.g. by means of the sending module 1502 within the radio network node 110, configured to send the request configured to be obtained to the second node 102. To obtain the first indication may be configured to be based on the request configured to be sent.

In some embodiments, the first indication may be configured to indicate whether or not the second node 102 supports detection of positioning broadcast information while in connected mode.

The radio network node 110 may be further configured to perform the obtaining of Action 505, e.g. by means of the obtaining module 1503 within the radio network node 110, configured to obtain, from the second node 102, the second indication configured to indicate the scope of assistance data to be requested by the second node 102. The one or more characteristics of the assistance data may be configured to be indicated by the second indication configured to be obtained.

The radio network node 110 may be further configured to perform the sending of Action 506, e.g. by means of the sending module 1502 within the radio network node 110, configured to send the second indication configured to be obtained to the first node 101.

In some embodiments, the radio network node 110 may be further configured to perform the sending of Action 507, e.g. by means of the sending module 1502 within the radio network node 110, configured to send, to the first node 101, at least the third indication configured to indicate at least one of: the load of the wireless communications network 100 and the efficiency of provisioning of the assistance data to the second node 102. The one or more characteristics of the wireless communications network 100 may be configured to be indicated by the third indication configured to be sent.

Other modules 1504 may be comprised in the radio network node 110.

The embodiments herein in the radio network node 110 may be implemented through one or more processors, such as a processor 1505 in the radio network node 110 depicted in FIG. 15a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the radio network node 110. One such carrier may be in the form of a CD ROM disc. It is however feasible with other data carriers such as a memory stick. The computer program code may furthermore be provided as pure program code on a server and downloaded to the radio network node 110.

The radio network node 110 may further comprise a memory 1506 comprising one or more memory units. The memory 1506 is arranged to be used to store obtained information, store data, configurations, schedulings, and applications etc. to perform the methods herein when being executed in the radio network node 110.

In some embodiments, the radio network node 110 may receive information from, e.g., the first node 101, the second node 102, or the mobility management entity 115, through a receiving port 1507. In some embodiments, the receiving port 1507 may be, for example, connected to one or more antennas in radio network node 110. In other embodiments, the radio network node 110 may receive information from another structure in the wireless communications network 100 through the receiving port 1507. Since the receiving port 1507 may be in communication with the processor 1505, the receiving port 1507 may then send the received information to the processor 1505. The receiving port 1507 may also be configured to receive other information.

The processor 1505 in the radio network node 110 may be further configured to transmit or send information to e.g., the first node 101, the second node 102, or the mobility management entity 115, or another structure in the wireless communications network 100, through a sending port 1508, which may be in communication with the processor 1505, and the memory 1506.

Those skilled in the art will also appreciate that the receiving module 1501, the sending module 1502, the obtaining module 1503, and the other modules 1504 described above may refer to a combination of analog and digital modules, and/or one or more processors configured with software and/or firmware, e.g., stored in memory, that, when executed by the one or more processors such as the processor 1505, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1501-1504 described above may be implemented as one or more applications running on one or more processors such as the processor 1505.

Thus, the methods according to the embodiments described herein for the radio network node 110 may be respectively implemented by means of a computer program 1509 product, comprising instructions, i.e., software code portions, which, when executed on at least one processor 1505, cause the at least one processor 1505 to carry out the actions described herein, as performed by the radio network node 110. The computer program 1509 product may be stored on a computer-readable storage medium 1510. The computer-readable storage medium 1510, having stored thereon the computer program 1509, may comprise instructions which, when executed on at least one processor 1505, cause the at least one processor 1505 to carry out the actions described herein, as performed by the radio network node 110. In some embodiments, the computer-readable storage medium 1510 may be a non-transitory computer-readable storage medium, such as a CD ROM disc, or a memory stick. In other embodiments, the computer program 1509 product may be stored on a carrier containing the computer program 1509 just described, wherein the carrier is one of an electronic signal, optical signal, radio signal, or the computer-readable storage medium 1510, as described above.

The radio network node 110 may comprise a communication interface configured to facilitate communications between the radio network node 110 and other nodes or devices, e.g., the first node 101. The interface may, for example, include a transceiver configured to transmit and receive radio signals over an air interface in accordance with a suitable standard.

In other embodiments, the radio network node 110 may comprise the following arrangement depicted in FIG. 15b. The radio network node 110 may comprise a processing circuitry 1505, e.g., one or more processors such as the processor 1505, in the radio network node 110 and the memory 1506. The radio network node 110 may also comprise a radio circuitry 1511, which may comprise e.g., the receiving port 1507 and the sending port 1508. The processing circuitry 1505 may be configured to, or operable to, perform the method actions according to FIG. 5, FIG. 9, FIG. 11, and/or FIG. 12, in a similar manner as that described in relation to FIG. 15a. The radio circuitry 1511 may be configured to set up and maintain at least a wireless connection with the first node 101. Circuitry may be understood herein as a hardware component.

Hence, embodiments herein also relate to the radio network node 110 operative to handle assistance data about the location of the radio network node 110, the radio network node 110 being operative to operate in the wireless communications network 100. The radio network node 110 may comprise the processing circuitry 1505 and the memory 1506, said memory 1506 containing instructions executable by said processing circuitry 1505, whereby the radio network node 110 is further operative to perform the actions described herein in relation to the radio network node 110, e.g., in FIG. 5, FIG. 9, FIG. 11, and/or FIG. 12.

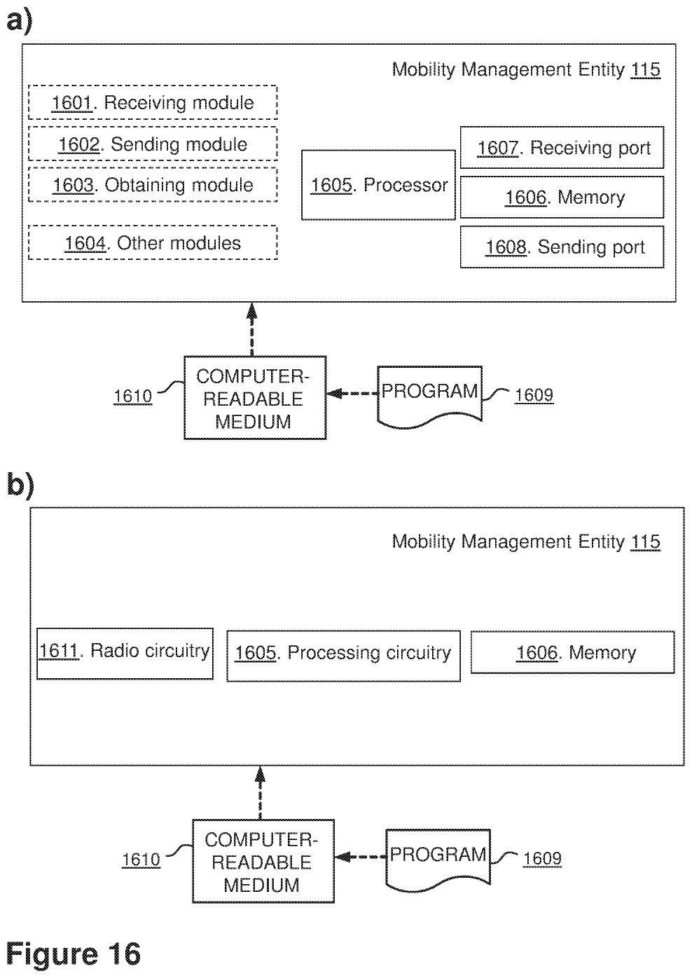

FIG. 16 depicts two different examples in panels a) and b), respectively, of the arrangement that the mobility management entity 115 may comprise to perform the method actions described above in relation to FIG. 6. In some embodiments, the mobility management entity 115 may comprise the following arrangement depicted in FIG. 16a. The mobility management entity 115 is configured to handle assistance data about the location of the mobility management entity 115. The mobility management entity 115 and the second node 102 are further configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the mobility management entity 115, and will thus not be repeated here. For example, the first node 101 may be the location server 105 and the mobility management entity 115 may be the wireless device 130.

In FIG. 16, optional modules are indicated with dashed boxes.

The mobility management entity 115 is configured to perform the receiving of Action 610, e.g. by means of a receiving module 1601 within the mobility management entity 115, configured to receive, from the first node 101 configured to operate in the wireless communications network 100 the first set of the assistance data to be provided to the second node 102 via unicast, and the second set of the assistance data to be provided to the second node 102 via broadcast. To receive is configured to be based on the one or more characteristics of at least one of: the second node 102, the assistance data, the wireless communications network 100, and the radio coverage of the second node 102. The receiving module 1601 may be a processor 1605 of the mobility management entity 115, or an application running on such processor.

The mobility management entity 115 is configured to perform the sending of Action 611, e.g. by means of a sending module 1602 within the mobility management entity 115, configured to send, to the second node 102, the first set of the assistance data via unicast, and the second set of the assistance data via broadcast. The sending module 1602 may be the processor 1605 of the mobility management entity 115, or an application running on such processor.

The mobility management entity 115 may be further configured to perform the receiving of Action 608, e.g. by means of the receiving module 1601 within the mobility management entity 115, configured to receive, from the first node 101, the indication configured to indicate the first set of the assistance data to be provided to the second node 102 via unicast, and the second set of the assistance data to be provided to the second node 102 via broadcast.

The mobility management entity 115 may be further configured to perform the sending of Action 609, e.g. by means of the sending module 1602 within the mobility management entity 115, configured to send the indication configured to be received, to the second node 102.

In some embodiments, at least one of the following may apply: a) the one or more characteristics of the mobility management entity 115 may comprise the capability of the mobility management entity 115; b) the one or more characteristics of the assistance data may comprise at least one of: i) information on the validity of the first set of the assistance data and second set of the assistance data, and ii) an interest on the first set of the assistance data and second set of the assistance data; c) the one or more characteristics of the wireless communications network 100 may comprise at least one of: i) the load of the wireless communications network 100 and the efficiency of provisioning of the assistance data to the mobility management entity 115; and d) the one or more characteristics of the radio coverage of the mobility management entity 115 may comprise one of: i) the potential beamforming gain of the unicast transmission or the broadcast transmission, and ii) the radio condition information configured to be provided by the mobility management entity 115 in the request for the assistance data.

In some embodiments, based on the determination, the first set of the assistance data may be configured to comprise at least one of: i) data supported by a lower number of devices in the wireless communications network 100 than the data in the second set of assistance data; ii) data with a longer validity than the data in the second set of assistance data, iii) data to be provided at a lower frequency than data in the second set of assistance data, iv) data with a higher security sensitivity than data in the second set of assistance data, v) data for users with a higher priority than users of the data in the second set of assistance data, vi) data of interest to a lower number of devices in the wireless communications network 100 than the data in the second set of assistance data, vii) data to be provided in low load conditions of the wireless communications network 100, viii) data to be provided with higher efficiency than via broadcast, ix) data to be provided with higher beamforming gain than with broadcast transmission, and x) data to be provided with better radio coverage than with broadcast transmission.

The mobility management entity 115 may be further configured to perform the obtaining of Action 603, e.g. by means of an obtaining module 1603 within the mobility management entity 115, configured to obtain, from the second node 102, the first indication configured to indicate the capability the second node 102, the capability being about positioning. The one or more characteristics of the second node 102 may be configured to be indicated by the obtained first indication. The obtaining module 1603 may be a processor 1605 of the mobility management entity 115, or an application running on such processor.

The mobility management entity 115 may be further configured to perform the sending of Action 604, e.g. by means of the sending module 1602 within the mobility management entity 115, configured to send the obtained first indication to the first node 101.

The mobility management entity 115 may be further configured to perform the obtaining of Action 601, e.g. by means of the obtaining module 1603 within the mobility management entity 115, configured to obtain, from the first node 101, the request to the second node 102 to provide the capability of the second node 102, the capability being about positioning.

The mobility management entity 115 may be further configured to perform the sending of Action 602, e.g. by means of the sending module 1602 within the mobility management entity 115, configured to send the request configured to be obtained to the second node 102. To obtain the first indication may be configured to be based on the request configured to be sent.

In some embodiments, the first indication may be configured to indicate whether or not the second node 102 supports detection of positioning broadcast information while in connected mode.

The mobility management entity 115 may be further configured to perform the obtaining of Action 605, e.g. by means of the obtaining module 1603 within the mobility management entity 115, configured to obtain, from the second node 102, the second indication configured to indicate the scope of assistance data to be requested by the second node 102. The one or more characteristics of the assistance data may be configured to be indicated by the second indication configured to be obtained.

The mobility management entity 115 may be further configured to perform the sending of Action 606, e.g. by means of the sending module 1602 within the mobility management entity 115, configured to send the second indication configured to be obtained to the first node 101.

In some embodiments, the mobility management entity 115 may be further configured to perform the sending of Action 607, e.g. by means of the sending module 1602 within the mobility management entity 115, configured to send, to the first node 101, at least the third indication configured to indicate at least one of: the load of the wireless communications network 100 and the efficiency of provisioning of the assistance data to the second node 102. The one or more characteristics of the wireless communications network 100 may be configured to be indicated by the third indication configured to be sent.

Other modules 1604 may be comprised in the mobility management entity 115.

The embodiments herein in the mobility management entity 115 may be implemented through one or more processors, such as a processor 1605 in the mobility management entity 115 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the mobility management entity 115. One such carrier may be in the form of a CD ROM disc. It is however feasible with other data carriers such as a memory stick. The computer program code may furthermore be provided as pure program code on a server and downloaded to the mobility management entity 115.

The mobility management entity 115 may further comprise a memory 1606 comprising one or more memory units. The memory 1606 is arranged to be used to store obtained information, store data, configurations, schedulings, and applications etc. to perform the methods herein when being executed in the mobility management entity 115.

In some embodiments, the mobility management entity 115 may receive information from, e.g., the first node 101, the second node 102, or the radio network 110, through a receiving port 1607. In some embodiments, the receiving port 1607 may be, for example, connected to one or more antennas in mobility management entity 115. In other embodiments, the mobility management entity 115 may receive information from another structure in the wireless communications network 100 through the receiving port 1607. Since the receiving port 1607 may be in communication with the processor 1605, the receiving port 1607 may then send the received information to the processor 1605. The receiving port 1607 may also be configured to receive other information.

The processor 1605 in the mobility management entity 115 may be further configured to transmit or send information to e.g., the first node 101, the second node 102, or the radio network 110, or another structure in the wireless communications network 100, through a sending port 1608, which may be in communication with the processor 1605, and the memory 1606.

Those skilled in the art will also appreciate that the receiving module 1601, the sending module 1602, the obtaining module 1603, and the other modules 1604 described above may refer to a combination of analog and digital modules, and/or one or more processors configured with software and/or firmware, e.g., stored in memory, that, when executed by the one or more processors such as the processor 1605, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1601-1604 described above may be implemented as one or more applications running on one or more processors such as the processor 1605.

Thus, the methods according to the embodiments described herein for the mobility management entity 115 may be respectively implemented by means of a computer program 1609 product, comprising instructions, i.e., software code portions, which, when executed on at least one processor 1605, cause the at least one processor 1605 to carry out the actions described herein, as performed by the mobility management entity 115. The computer program 1609 product may be stored on a computer-readable storage medium 1610. The computer-readable storage medium 1610, having stored thereon the computer program 1609, may comprise instructions which, when executed on at least one processor 1605, cause the at least one processor 1605 to carry out the actions described herein, as performed by the mobility management entity 115. In some embodiments, the computer-readable storage medium 1610 may be a non-transitory computer-readable storage medium, such as a CD ROM disc, or a memory stick. In other embodiments, the computer program 1609 product may be stored on a carrier containing the computer program 1609 just described, wherein the carrier is one of an electronic signal, optical signal, radio signal, or the computer-readable storage medium 1610, as described above.

The mobility management entity 115 may comprise a communication interface configured to facilitate communications between the mobility management entity 115 and other nodes or devices, e.g., the first node 101, the second node 102, and/or the radio network 110. The interface may, for example, include a transceiver configured to transmit and receive radio signals over an air interface in accordance with a suitable standard.

In other embodiments, the mobility management entity 115 may comprise the following arrangement depicted in FIG. 16b. The mobility management entity 115 may comprise a processing circuitry 1605, e.g., one or more processors such as the processor 1605, in the mobility management entity 115 and the memory 1606. The mobility management entity 115 may also comprise a radio circuitry 1611, which may comprise e.g., the receiving port 1607 and the sending port 1608. The processing circuitry 1605 may be configured to, or operable to, perform the method actions according to FIG. 6, and/or FIG. 9, in a similar manner as that described in relation to FIG. 16a. The radio circuitry 1611 may be configured to set up and maintain at least a wireless connection with the first node 101. Circuitry may be understood herein as a hardware component.

Hence, embodiments herein also relate to the mobility management entity 115 operative to handle assistance data about the location of the mobility management entity 115, the mobility management entity 115 being operative to operate in the wireless communications network 100. The mobility management entity 115 may comprise the processing circuitry 1605 and the memory 1606, said memory 1606 containing instructions executable by said processing circuitry 1605, whereby the mobility management entity 115 is further operative to perform the actions described herein in relation to the mobility management entity 115, e.g., in FIG. 6, and/or FIG. 9.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### Examples Related to Embodiments

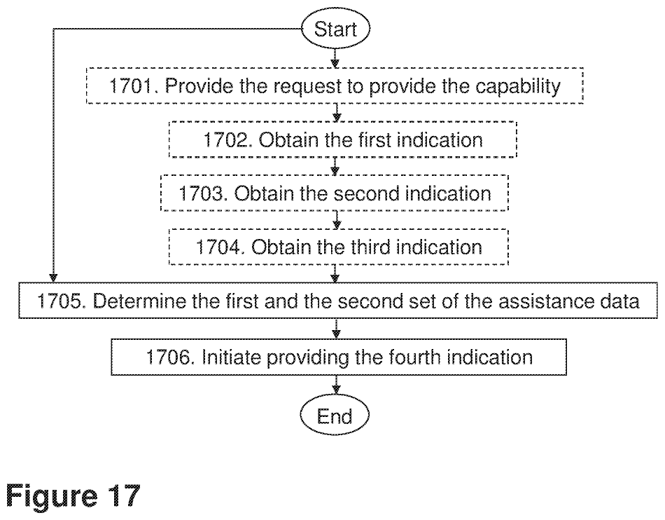

FIG. 17 relates to the first node 101 embodiments. FIG. 17 is a flowchart depicting a method, performed by the first node 101, which may comprise one or more of the depicted actions, according to the corresponding description already provided. In FIG. 17, optional actions are indicated with dashed lines.

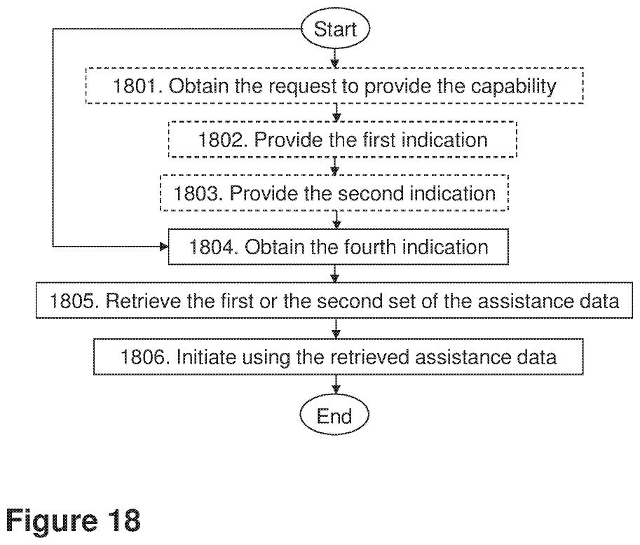

FIG. 18 relates to the second node 102 embodiments. FIG. 18 is a flowchart depicting a method, performed by the second node 102, which may comprise one or more of the depicted actions, according to the corresponding description already provided. In FIG. 18, optional actions are indicated with dashed lines.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Further Extensions And Variations

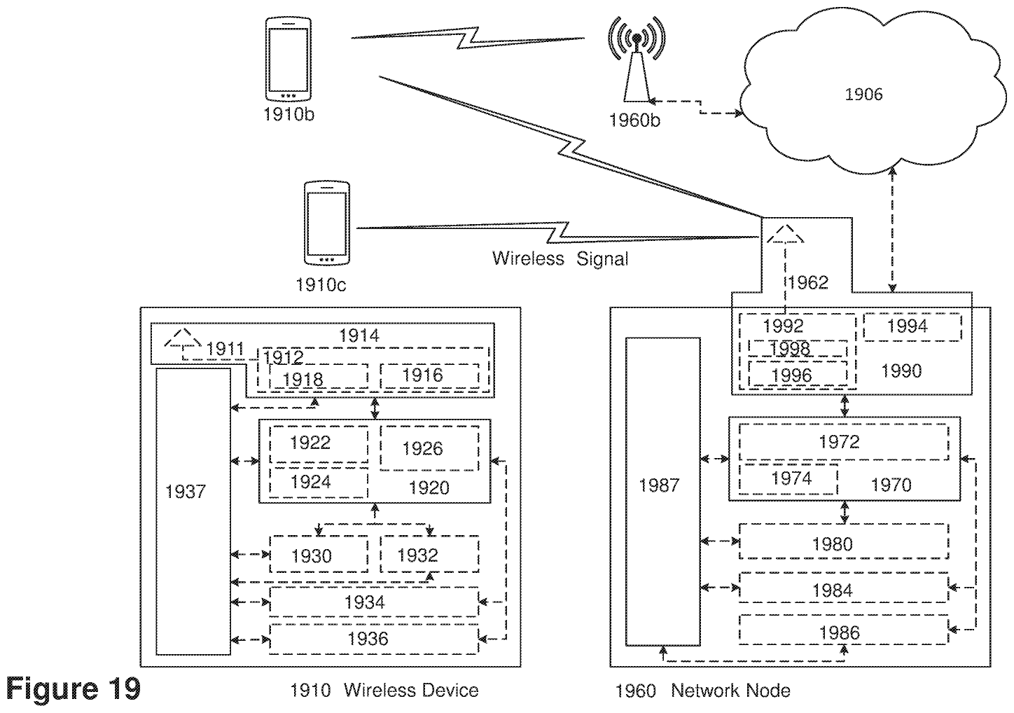

FIG. 19: A wireless network in accordance with some embodiments.

Although the subject matter described herein may be implemented in any appropriate type of system using any suitable components, the embodiments disclosed herein may be described in relation to a wireless network, such as the example wireless network illustrated in FIG. 19. For simplicity, the wireless network of FIG. 19 only depicts network 1906, network nodes 1960 and 1960b, and WDs 1910, 1910b, and 1910c. In practice, a wireless network may further include any additional elements suitable to support communication between wireless devices or between a wireless device and another communication device, such as a landline telephone, a service provider, or any other network node or end device. Of the illustrated components, network node 1960, such as any of the first node 101, the second network node, such as a radio network node 110, and the third network node 115 described above, and wireless device (WD) 1910, such as the wireless device 130 described above, are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1960 and WD 1910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 19, network node 1960 includes processing circuitry 1970, device readable medium 1980, interface 1990, auxiliary equipment 1984, power source 1986, power circuitry 1987, and antenna 1962. Although network node 1960 illustrated in the example wireless network of FIG. 19 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1960 are depicted as single boxes located within a larger box, or nested within multiple boxes, in practice, a network node may comprise multiple different physical components that make up a single illustrated component (e.g., device readable medium 1980 may comprise multiple separate hard drives as well as multiple RAM modules).

Similarly, network node 1960 may be composed of multiple physically separate components (e.g., a NodeB component and a RNC component, or a BTS component and a BSC component, etc.), which may each have their own respective components. In certain scenarios in which network node 1960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1960 may be configured to support multiple radio access technologies (RATs). In such embodiments, some components may be duplicated (e.g., separate device readable medium 1980 for the different RATs) and some components may be reused (e.g., the same antenna 1962 may be shared by the RATs). Network node 1960 may also include multiple sets of the various illustrated components for different wireless technologies integrated into network node 1960, such as, for example, GSM, WCDMA, LTE, NR, WiFi, or Bluetooth wireless technologies. These wireless technologies may be integrated into the same or different chip or set of chips and other components within network node 1960.

Processing circuitry 1970 is configured to perform any determining, calculating, or similar operations (e.g., certain obtaining operations) described herein as being provided by a network node. These operations performed by processing circuitry 1970 may include processing information obtained by processing circuitry 1970 by, for example, converting the obtained information into other information, comparing the obtained information or converted information to information stored in the network node, and/or performing one or more operations based on the obtained information or converted information, and as a result of said processing making a determination.

Processing circuitry 1970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1960 components, such as device readable medium 1980, network node 1960 functionality. For example, processing circuitry 1970 may execute instructions stored in device readable medium 1980 or in memory within processing circuitry 1970. Such functionality may include providing any of the various wireless features, functions, or benefits discussed herein. In some embodiments, processing circuitry 1970 may include a system on a chip (SOC).

In some embodiments, processing circuitry 1970 may include one or more of radio frequency (RF) transceiver circuitry 1972 and baseband processing circuitry 1974. In some embodiments, radio frequency (RF) transceiver circuitry 1972 and baseband processing circuitry 1974 may be on separate chips (or sets of chips), boards, or units, such as radio units and digital units. In alternative embodiments, part or all of RF transceiver circuitry 1972 and baseband processing circuitry 1974 may be on the same chip or set of chips, boards, or units

In certain embodiments, some or all of the functionality described herein as being provided by a network node, base station, eNB or other such network device may be performed by processing circuitry 1970 executing instructions stored on device readable medium 1980 or memory within processing circuitry 1970. In alternative embodiments, some or all of the functionality may be provided by processing circuitry 1970 without executing instructions stored on a separate or discrete device readable medium, such as in a hard-wired manner. In any of those embodiments, whether executing instructions stored on a device readable storage medium or not, processing circuitry 1970 can be configured to perform the described functionality. The benefits provided by such functionality are not limited to processing circuitry 1970 alone or to other components of network node 1960, but are enjoyed by network node 1960 as a whole, and/or by end users and the wireless network generally.

Device readable medium 1980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1970. Device readable medium 1980 may store any suitable instructions, data or information, including a computer program, software, an application including one or more of logic, rules, code, tables, etc. and/or other instructions capable of being executed by processing circuitry 1970 and, utilized by network node 1960. Device readable medium 1980 may be used to store any calculations made by processing circuitry 1970 and/or any data received via interface 1990. In some embodiments, processing circuitry 1970 and device readable medium 1980 may be considered to be integrated.

Interface 1990 is used in the wired or wireless communication of signalling and/or data between network node 1960, network 1906, and/or WDs 1910. As illustrated, interface 1990 comprises port(s)/terminal(s) 1994 to send and receive data, for example to and from network 1906 over a wired connection. Interface 1990 also includes radio front end circuitry 1992 that may be coupled to, or in certain embodiments a part of, antenna 1962. Radio front end circuitry 1992 comprises filters 1998 and amplifiers 1996. Radio front end circuitry 1992 may be connected to antenna 1962 and processing circuitry 1970. Radio front end circuitry may be configured to condition signals communicated between antenna 1962 and processing circuitry 1970. Radio front end circuitry 1992 may receive digital data that is to be sent out to other network nodes or WDs via a wireless connection. Radio front end circuitry 1992 may convert the digital data into a radio signal having the appropriate channel and bandwidth parameters using a combination of filters 1998 and/or amplifiers 1996. The radio signal may then be transmitted via antenna 1962. Similarly, when receiving data, antenna 1962 may collect radio signals which are then converted into digital data by radio front end circuitry 1992. The digital data may be passed to processing circuitry 1970. In other embodiments, the interface may comprise different components and/or different combinations of components.

In certain alternative embodiments, network node 1960 may not include separate radio front end circuitry 1992, instead, processing circuitry 1970 may comprise radio front end circuitry and may be connected to antenna 1962 without separate radio front end circuitry 1992. Similarly, in some embodiments, all or some of RF transceiver circuitry 1972 may be considered a part of interface 1990. In still other embodiments, interface 1990 may include one or more ports or terminals 1994, radio front end circuitry 1992, and RF transceiver circuitry 1972, as part of a radio unit (not shown), and interface 1990 may communicate with baseband processing circuitry 1974, which is part of a digital unit (not shown).

Antenna 1962 may include one or more antennas, or antenna arrays, configured to send and/or receive wireless signals. Antenna 1962 may be coupled to radio front end circuitry 1990 and may be any type of antenna capable of transmitting and receiving data and/or signals wirelessly. In some embodiments, antenna 1962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1962 may be separate from network node 1960 and may be connectable to network node 1960 through an interface or port.

Antenna 1962, interface 1990, and/or processing circuitry 1970 may be configured to perform any receiving operations and/or certain obtaining operations described herein as being performed by a network node. Any information, data and/or signals may be received from a wireless device, another network node and/or any other network equipment. Similarly, antenna 1962, interface 1990, and/or processing circuitry 1970 may be configured to perform any transmitting operations described herein as being performed by a network node. Any information, data and/or signals may be transmitted to a wireless device, another network node and/or any other network equipment.

Power circuitry 1987 may comprise, or be coupled to, power management circuitry and is configured to supply the components of network node 1960 with power for performing the functionality described herein. Power circuitry 1987 may receive power from power source 1986. Power source 1986 and/or power circuitry 1987 may be configured to provide power to the various components of network node 1960 in a form suitable for the respective components (e.g., at a voltage and current level needed for each respective component). Power source 1986 may either be included in, or external to, power circuitry 1987 and/or network node 1960. For example, network node 1960 may be connectable to an external power source (e.g., an electricity outlet) via an input circuitry or interface such as an electrical cable, whereby the external power source supplies power to power circuitry 1987. As a further example, power source 1986 may comprise a source of power in the form of a battery or battery pack which is connected to, or integrated in, power circuitry 1987. The battery may provide backup power should the external power source fail. Other types of power sources, such as photovoltaic devices, may also be used.

Alternative embodiments of network node 1960 may include additional components beyond those shown in FIG. 19 that may be responsible for providing certain aspects of the network node's functionality, including any of the functionality described herein and/or any functionality necessary to support the subject matter described herein. For example, network node 1960 may include user interface equipment to allow input of information into network node 1960 and to allow output of information from network node 1960. This may allow a user to perform diagnostic, maintenance, repair, and other administrative functions for network node 1960.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1910 includes antenna 1911, interface 1914, processing circuitry 1920, device readable medium 1930, user interface equipment 1932, auxiliary equipment 1934, power source 1936 and power circuitry 1937. WD 1910 may include multiple sets of one or more of the illustrated components for different wireless technologies supported by WD 1910, such as, for example, GSM, WCDMA, LTE, NR, WiFi, WiMAX, or Bluetooth wireless technologies, just to mention a few. These wireless technologies may be integrated into the same or different chips or set of chips as other components within WD 1910.

Antenna 1911 may include one or more antennas or antenna arrays, configured to send and/or receive wireless signals, and is connected to interface 1914. In certain alternative embodiments, antenna 1911 may be separate from WD 1910 and be connectable to WD 1910 through an interface or port. Antenna 1911, interface 1914, and/or processing circuitry 1920 may be configured to perform any receiving or transmitting operations described herein as being performed by a WD. Any information, data and/or signals may be received from a network node and/or another WD. In some embodiments, radio front end circuitry and/or antenna 1911 may be considered an interface.

As illustrated, interface 1914 comprises radio front end circuitry 1912 and antenna 1911. Radio front end circuitry 1912 comprise one or more filters 1918 and amplifiers 1916. Radio front end circuitry 1914 is connected to antenna 1911 and processing circuitry 1920, and is configured to condition signals communicated between antenna 1911 and processing circuitry 1920. Radio front end circuitry 1912 may be coupled to or a part of antenna 1911. In some embodiments, WD 1910 may not include separate radio front end circuitry 1912; rather, processing circuitry 1920 may comprise radio front end circuitry and may be connected to antenna 1911. Similarly, in some embodiments, some or all of RF transceiver circuitry 1922 may be considered a part of interface 1914. Radio front end circuitry 1912 may receive digital data that is to be sent out to other network nodes or WDs via a wireless connection. Radio front end circuitry 1912 may convert the digital data into a radio signal having the appropriate channel and bandwidth parameters using a combination of filters 1918 and/or amplifiers 1916. The radio signal may then be transmitted via antenna 1911. Similarly, when receiving data, antenna 1911 may collect radio signals which are then converted into digital data by radio front end circuitry 1912. The digital data may be passed to processing circuitry 1920. In other embodiments, the interface may comprise different components and/or different combinations of components.

Processing circuitry 1920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1910 components, such as device readable medium 1930, WD 1910 functionality. Such functionality may include providing any of the various wireless features or benefits discussed herein. For example, processing circuitry 1920 may execute instructions stored in device readable medium 1930 or in memory within processing circuitry 1920 to provide the functionality disclosed herein.

As illustrated, processing circuitry 1920 includes one or more of RF transceiver circuitry 1922, baseband processing circuitry 1924, and application processing circuitry 1926. In other embodiments, the processing circuitry may comprise different components and/or different combinations of components. In certain embodiments processing circuitry 1920 of WD 1910 may comprise a SOC. In some embodiments, RF transceiver circuitry 1922, baseband processing circuitry 1924, and application processing circuitry 1926 may be on separate chips or sets of chips. In alternative embodiments, part or all of baseband processing circuitry 1924 and application processing circuitry 1926 may be combined into one chip or set of chips, and RF transceiver circuitry 1922 may be on a separate chip or set of chips. In still alternative embodiments, part or all of RF transceiver circuitry 1922 and baseband processing circuitry 1924 may be on the same chip or set of chips, and application processing circuitry 1926 may be on a separate chip or set of chips. In yet other alternative embodiments, part or all of RF transceiver circuitry 1922, baseband processing circuitry 1924, and application processing circuitry 1926 may be combined in the same chip or set of chips. In some embodiments, RF transceiver circuitry 1922 may be a part of interface 1914. RF transceiver circuitry 1922 may condition RF signals for processing circuitry 1920.

In certain embodiments, some or all of the functionality described herein as being performed by a WD may be provided by processing circuitry 1920 executing instructions stored on device readable medium 1930, which in certain embodiments may be a computer-readable storage medium. In alternative embodiments, some or all of the functionality may be provided by processing circuitry 1920 without executing instructions stored on a separate or discrete device readable storage medium, such as in a hard-wired manner. In any of those particular embodiments, whether executing instructions stored on a device readable storage medium or not, processing circuitry 1920 can be configured to perform the described functionality. The benefits provided by such functionality are not limited to processing circuitry 1920 alone or to other components of WD 1910, but are enjoyed by WD 1910 as a whole, and/or by end users and the wireless network generally.

Processing circuitry 1920 may be configured to perform any determining, calculating, or similar operations (e.g., certain obtaining operations) described herein as being performed by a WD. These operations, as performed by processing circuitry 1920, may include processing information obtained by processing circuitry 1920 by, for example, converting the obtained information into other information, comparing the obtained information or converted information to information stored by WD 1910, and/or performing one or more operations based on the obtained information or converted information, and as a result of said processing making a determination.

Device readable medium 1930 may be operable to store a computer program, software, an application including one or more of logic, rules, code, tables, etc. and/or other instructions capable of being executed by processing circuitry 1920. Device readable medium 1930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1920. In some embodiments, processing circuitry 1920 and device readable medium 1930 may be considered to be integrated.

User interface equipment 1932 may provide components that allow for a human user to interact with WD 1910. Such interaction may be of many forms, such as visual, audial, tactile, etc. User interface equipment 1932 may be operable to produce output to the user and to allow the user to provide input to WD 1910. The type of interaction may vary depending on the type of user interface equipment 1932 installed in WD 1910. For example, if WD 1910 is a smart phone, the interaction may be via a touch screen; if WD 1910 is a smart meter, the interaction may be through a screen that provides usage (e.g., the number of gallons used) or a speaker that provides an audible alert (e.g., if smoke is detected). User interface equipment 1932 may include input interfaces, devices and circuits, and output interfaces, devices and circuits. User interface equipment 1932 is configured to allow input of information into WD 1910, and is connected to processing circuitry 1920 to allow processing circuitry 1920 to process the input information. User interface equipment 1932 may include, for example, a microphone, a proximity or other sensor, keys/buttons, a touch display, one or more cameras, a USB port, or other input circuitry. User interface equipment 1932 is also configured to allow output of information from WD 1910, and to allow processing circuitry 1920 to output information from WD 1910. User interface equipment 1932 may include, for example, a speaker, a display, vibrating circuitry, a USB port, a headphone interface, or other output circuitry. Using one or more input and output interfaces, devices, and circuits, of user interface equipment 1932, WD 1910 may communicate with end users and/or the wireless network, and allow them to benefit from the functionality described herein.

Auxiliary equipment 1934 is operable to provide more specific functionality which may not be generally performed by WDs. This may comprise specialized sensors for doing measurements for various purposes, interfaces for additional types of communication such as wired communications etc. The inclusion and type of components of auxiliary equipment 1934 may vary depending on the embodiment and/or scenario.

Power source 1936 may, in some embodiments, be in the form of a battery or battery pack. Other types of power sources, such as an external power source (e.g., an electricity outlet), photovoltaic devices or power cells, may also be used. WD 1910 may further comprise power circuitry 1937 for delivering power from power source 1936 to the various parts of WD 1910 which need power from power source 1936 to carry out any functionality described or indicated herein. Power circuitry 1937 may in certain embodiments comprise power management circuitry. Power circuitry 1937 may additionally or alternatively be operable to receive power from an external power source; in which case WD 1910 may be connectable to the external power source (such as an electricity outlet) via input circuitry or an interface such as an electrical power cable. Power circuitry 1937 may also in certain embodiments be operable to deliver power from an external power source to power source 1936. This may be, for example, for the charging of power source 1936. Power circuitry 1937 may perform any formatting, converting, or other modification to the power from power source 1936 to make the power suitable for the respective components of WD 1910 to which power is supplied.

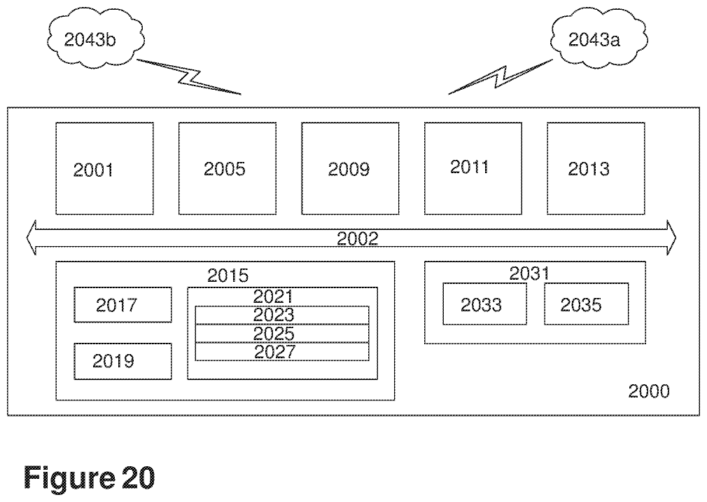

FIG. 20: User Equipment in Accordance with Some Embodiments

FIG. 20 illustrates one embodiment of a UE in accordance with various aspects described herein, such as wireless device 130. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 20200 may be any UE identified by the 3^{rd} Generation Partnership Project (3GPP), including a NB-IoT UE, a machine type communication (MTC) UE, and/or an enhanced MTC (eMTC) UE. UE 2000, as illustrated in FIG. 20, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 20 is a UE, the components discussed herein are equally applicable to a WD, and vice-versa.

In FIG. 20, UE 2000 includes processing circuitry 2001 that is operatively coupled to input/output interface 2005, radio frequency (RF) interface 2009, network connection interface 2011, memory 2015 including random access memory (RAM) 2017, read-only memory (ROM) 2019, and storage medium 2021 or the like, communication subsystem 2031, power source 2033, and/or any other component, or any combination thereof. Storage medium 2021 includes operating system 2023, application program 2025, and data 2027. In other embodiments, storage medium 2021 may include other similar types of information. Certain UEs may utilize all of the components shown in FIG. 20, or only a subset of the components. The level of integration between the components may vary from one UE to another UE. Further, certain UEs may contain multiple instances of a component, such as multiple processors, memories, transceivers, transmitters, receivers, etc.

In FIG. 20, processing circuitry 2001 may be configured to process computer instructions and data. Processing circuitry 2001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2001 may include two central processing units (CPUs). Data may be information in a form suitable for use by a computer.

In the depicted embodiment, input/output interface 2005 may be configured to provide a communication interface to an input device, output device, or input and output device. UE 2000 may be configured to use an output device via input/output interface 2005. An output device may use the same type of interface port as an input device. For example, a USB port may be used to provide input to and output from UE 2000. The output device may be a speaker, a sound card, a video card, a display, a monitor, a printer, an actuator, an emitter, a smartcard, another output device, or any combination thereof. UE 2000 may be configured to use an input device via input/output interface 2005 to allow a user to capture information into UE 2000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 20, RF interface 2009 may be configured to provide a communication interface to RF components such as a transmitter, a receiver, and an antenna. Network connection interface 2011 may be configured to provide a communication interface to network 2043a. Network 2043a may encompass wired and/or wireless networks such as a local-area network (LAN), a wide-area network (WAN), a computer network, a wireless network, a telecommunications network, another like network or any combination thereof. For example, network 2043a may comprise a Wi-Fi network. Network connection interface 2011 may be configured to include a receiver and a transmitter interface used to communicate with one or more other devices over a communication network according to one or more communication protocols, such as Ethernet, TCP/IP, SONET, ATM, or the like. Network connection interface 2011 may implement receiver and transmitter functionality appropriate to the communication network links (e.g., optical, electrical, and the like). The transmitter and receiver functions may share circuit components, software or firmware, or alternatively may be implemented separately.

RAM 2017 may be configured to interface via bus 2002 to processing circuitry 2001 to provide storage or caching of data or computer instructions during the execution of software programs such as the operating system, application programs, and device drivers. ROM 2019 may be configured to provide computer instructions or data to processing circuitry 2001. For example, ROM 2019 may be configured to store invariant low-level system code or data for basic system functions such as basic input and output (I/O), startup, or reception of keystrokes from a keyboard that are stored in a non-volatile memory. Storage medium 2021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2021 may be configured to include operating system 2023, application program 2025 such as a web browser application, a widget or gadget engine or another application, and data file 2027. Storage medium 2021 may store, for use by UE 2000, any of a variety of various operating systems or combinations of operating systems.

Storage medium 2021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2021 may allow UE 2000 to access computer-executable instructions, application programs or the like, stored on transitory or non-transitory memory media, to off-load data, or to upload data. An article of manufacture, such as one utilizing a communication system may be tangibly embodied in storage medium 2021, which may comprise a device readable medium.

In FIG. 20, processing circuitry 2001 may be configured to communicate with network 2043b using communication subsystem 2031. Network 2043a and network 2043b may be the same network or networks or different network or networks. Communication subsystem 2031 may be configured to include one or more transceivers used to communicate with network 2043b. For example, communication subsystem 2031 may be configured to include one or more transceivers used to communicate with one or more remote transceivers of another device capable of wireless communication such as another WD, UE, or base station of a radio access network (RAN) according to one or more communication protocols, such as IEEE 802.20, CDMA, WCDMA, GSM, LTE, UTRAN, WiMax, or the like. Each transceiver may include transmitter 2033 and/or receiver 2035 to implement transmitter or receiver functionality, respectively, appropriate to the RAN links (e.g., frequency allocations and the like). Further, transmitter 2033 and receiver 2035 of each transceiver may share circuit components, software or firmware, or alternatively may be implemented separately.

In the illustrated embodiment, the communication functions of communication subsystem 2031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2031 may include cellular communication, Wi-Fi communication, Bluetooth communication, and GPS communication. Network 2043b may encompass wired and/or wireless networks such as a local-area network (LAN), a wide-area network (WAN), a computer network, a wireless network, a telecommunications network, another like network or any combination thereof. For example, network 2043b may be a cellular network, a Wi-Fi network, and/or a near-field network. Power source 2013 may be configured to provide alternating current (AC) or direct current (DC) power to components of UE 2000.

The features, benefits and/or functions described herein may be implemented in one of the components of UE 2000 or partitioned across multiple components of UE 2000. Further, the features, benefits, and/or functions described herein may be implemented in any combination of hardware, software or firmware. In one example, communication subsystem 2031 may be configured to include any of the components described herein. Further, processing circuitry 2001 may be configured to communicate with any of such components over bus 2002. In another example, any of such components may be represented by program instructions stored in memory that when executed by processing circuitry 2001 perform the corresponding functions described herein. In another example, the functionality of any of such components may be partitioned between processing circuitry 2001 and communication subsystem 2031. In another example, the non-computationally intensive functions of any of such components may be implemented in software or firmware and the computationally intensive functions may be implemented in hardware.

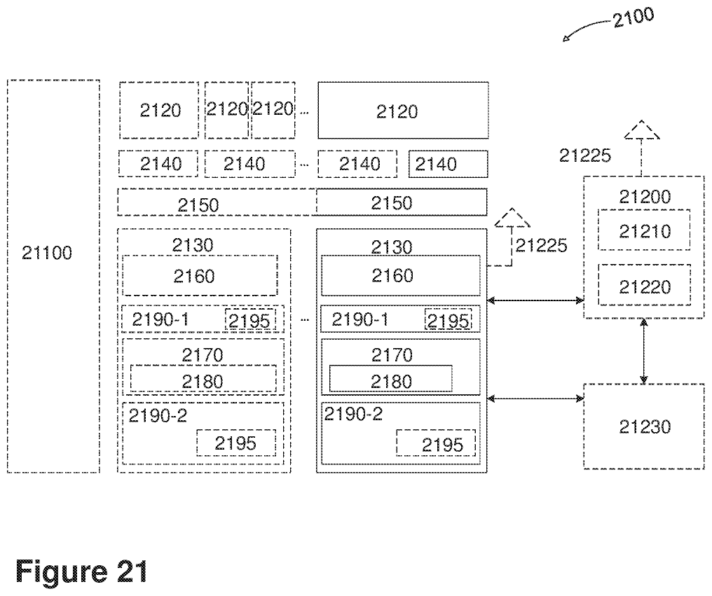

FIG. 21: Virtualization Environment in Accordance with Some Embodiments

FIG. 21 is a schematic block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node, such as radio network node 110, or another network node, such as the first node 101 or the third network node 115) or to a device (e.g., a UE, a wireless device or any other type of communication device, such as wireless device 130) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2100 hosted by one or more of hardware nodes 2130. Further, in embodiments in which the virtual node is not a radio access node or does not require radio connectivity (e.g., a core network node), then the network node may be entirely virtualized.

The functions may be implemented by one or more applications 2120 (which may alternatively be called software instances, virtual appliances, network functions, virtual nodes, virtual network functions, etc.) operative to implement some of the features, functions, and/or benefits of some of the embodiments disclosed herein. Applications 2120 are run in virtualization environment 2100 which provides hardware 2130 comprising processing circuitry 2160 and memory 2190. Memory 2190 contains instructions 2195 executable by processing circuitry 2160 whereby application 2120 is operative to provide one or more of the features, benefits, and/or functions disclosed herein.

Virtualization environment 2100, comprises general-purpose or special-purpose network hardware devices 2130 comprising a set of one or more processors or processing circuitry 2160, which may be commercial off-the-shelf (COTS) processors, dedicated Application Specific Integrated Circuits (ASICs), or any other type of processing circuitry including digital or analog hardware components or special purpose processors. Each hardware device may comprise memory 2190-1 which may be non-persistent memory for temporarily storing instructions 2195 or software executed by processing circuitry 2160. Each hardware device may comprise one or more network interface controllers (NICs) 2170, also known as network interface cards, which include physical network interface 2180. Each hardware device may also include non-transitory, persistent, machine-readable storage media 2190-2 having stored therein software 2195 and/or instructions executable by processing circuitry 2160. Software 2195 may include any type of software including software for instantiating one or more virtualization layers 2150 (also referred to as hypervisors), software to execute virtual machines 2140 as well as software allowing it to execute functions, features and/or benefits described in relation with some embodiments described herein.

Virtual machines 2140, comprise virtual processing, virtual memory, virtual networking or interface and virtual storage, and may be run by a corresponding virtualization layer 2150 or hypervisor. Different embodiments of the instance of virtual appliance 2120 may be implemented on one or more of virtual machines 2140, and the implementations may be made in different ways.

During operation, processing circuitry 2160 executes software 2195 to instantiate the hypervisor or virtualization layer 2150, which may sometimes be referred to as a virtual machine monitor (VMM). Virtualization layer 2150 may present a virtual operating platform that appears like networking hardware to virtual machine 2140.

As shown in FIG. 21, hardware 2130 may be a standalone network node with generic or specific components. Hardware 2130 may comprise antenna 21225 and may implement some functions via virtualization. Alternatively, hardware 2130 may be part of a larger cluster of hardware (e.g. such as in a data center or customer premise equipment (CPE)) where many hardware nodes work together and are managed via management and orchestration (MANO) 21100, which, among others, oversees lifecycle management of applications 2120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2140 may be a software implementation of a physical machine that runs programs as if they were executing on a physical, non-virtualized machine. Each of virtual machines 2140, and that part of hardware 2130 that executes that virtual machine, be it hardware dedicated to that virtual machine and/or hardware shared by that virtual machine with others of the virtual machines 2140, forms a separate virtual network elements (VNE).

Still in the context of NFV, Virtual Network Function (VNF) is responsible for handling specific network functions that run in one or more virtual machines 2140 on top of hardware networking infrastructure 2130 and corresponds to application 2120 in FIG. 21.

In some embodiments, one or more radio units 21200 that each include one or more transmitters 21220 and one or more receivers 21210 may be coupled to one or more antennas 21225. Radio units 21200 may communicate directly with hardware nodes 2130 via one or more appropriate network interfaces and may be used in combination with the virtual components to provide a virtual node with radio capabilities, such as a radio access node or a base station.

In some embodiments, some signalling can be effected with the use of control system 21230 which may alternatively be used for communication between the hardware nodes 2130 and radio units 21200.

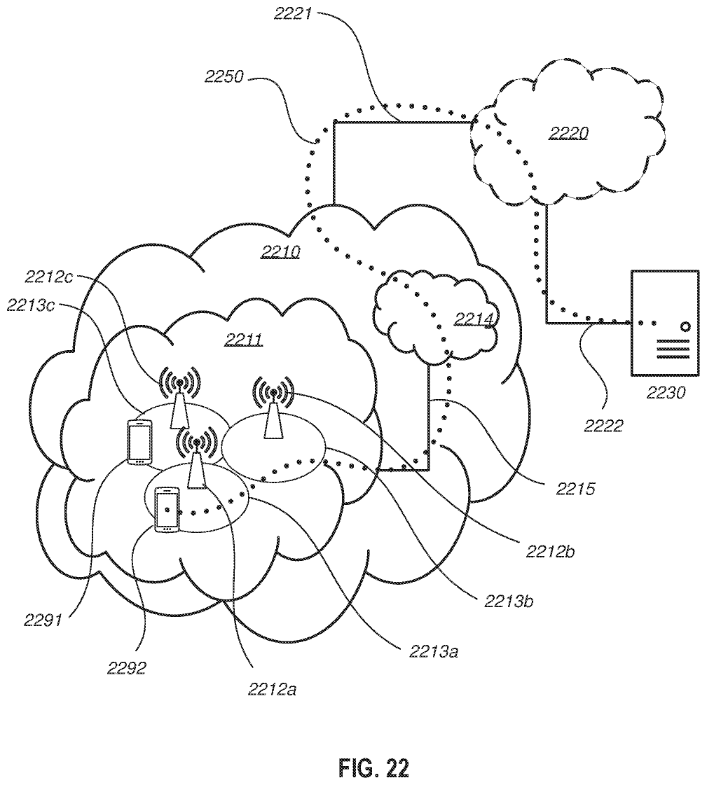

FIG. 22: Telecommunication Network Connected Via an Intermediate Network to a Host Computer in Accordance with Some Embodiments

With reference to FIG. 22, in accordance with an embodiment, a communication system includes telecommunication network 2210, such as the wireless communications network 100, for example, such as a 3GPP-type cellular network, which comprises access network 2211, such as a radio access network, and core network 2214. Access network 2211 comprises a plurality of base stations 2212a. 2212b, 2212c, such as the radio network node 110, for example, such as NBs, eNBs, gNBs or other types of wireless access points, each defining a corresponding coverage area 2213a, 2213b, 2213c. Each base station 2212a, 2212b. 2212c is connectable to core network 2214 over a wired or wireless connection 2215. A first UE 2291, such as the wireless device 130, located in coverage area 2213c is configured to wirelessly connect to, or be paged by, the corresponding base station 2212c. A second UE 2292 in coverage area 2213a is wirelessly connectable to the corresponding base station 2212a. While a plurality of UEs 2291, 2292 are illustrated in this example, the disclosed embodiments are equally applicable to a situation where a sole UE is in the coverage area or where a sole UE is connecting to the corresponding base station 2212. Any of the UEs 2291, 2292 are examples of the wireless device 130.

Telecommunication network 2210 is itself connected to host computer 2230, which may be embodied in the hardware and/or software of a standalone server, a cloud-implemented server, a distributed server or as processing resources in a server farm. Host computer 2230 may be under the ownership or control of a service provider, or may be operated by the service provider or on behalf of the service provider. Connections 2221 and 2222 between telecommunication network 2210 and host computer 2230 may extend directly from core network 2214 to host computer 2230 or may go via an optional intermediate network 2220. Intermediate network 2220 may be one of, or a combination of more than one of, a public, private or hosted network; intermediate network 2220, if any, may be a backbone network or the Internet; in particular, intermediate network 2220 may comprise two or more sub-networks (not shown).

The communication system of FIG. 22 as a whole enables connectivity between the connected UEs 2291, 2292 and host computer 2230. The connectivity may be described as an over-the-top (OTT) connection 2250. Host computer 2230 and the connected UEs 2291, 2292 are configured to communicate data and/or signaling via OTT connection 2250, using access network 2211, core network 2214, any intermediate network 2220 and possible further infrastructure (not shown) as intermediaries. OTT connection 2250 may be transparent in the sense that the participating communication devices through which OTT connection 2250 passes are unaware of routing of uplink and downlink communications. For example, base station 2212 may not or need not be informed about the past routing of an incoming downlink communication with data originating from host computer 2230 to be forwarded (e.g., handed over) to a connected UE 2291. Similarly, base station 2212 need not be aware of the future routing of an outgoing uplink communication originating from the UE 2291 towards the host computer 2230.

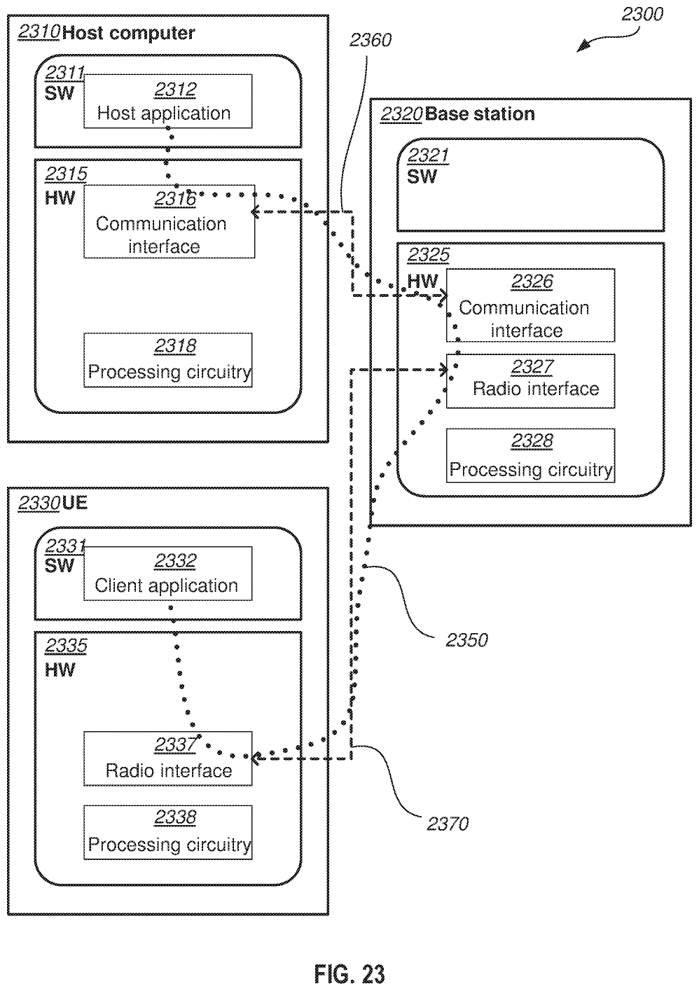

In relation to FIGS. 23, 24, 25, 26, and 27, which are described next, it may be understood that a UE is an example of the wireless device 130, and that any description provided for the UE equally applies to the wireless device 130. It may be also understood that the base station is an example of the radio network node 110, and that any description provided for the base station equally applies to the radio network node 110.

FIG. 23: Host Computer Communicating Via a Base Station with a User Equipment Over a Partially Wireless Connection in Accordance with Some embodiments

Example implementations, in accordance with an embodiment, of the UE, such as wireless device 130, base station and host computer discussed in the preceding paragraphs will now be described with reference to FIG. 23. In communication system 2300, such as the wireless communications network 100, host computer 2310 comprises hardware 2315 including communication interface 2316 configured to set up and maintain a wired or wireless connection with an interface of a different communication device of communication system 2300. Host computer 2310 further comprises processing circuitry 2318, which may have storage and/or processing capabilities. In particular, processing circuitry 2318 may comprise one or more programmable processors, application-specific integrated circuits, field programmable gate arrays or combinations of these (not shown) adapted to execute instructions. Host computer 2310 further comprises software 2311, which is stored in or accessible by host computer 2310 and executable by processing circuitry 2318. Software 2311 includes host application 2312. Host application 2312 may be operable to provide a service to a remote user, such as UE 2330 connecting via OTT connection 2350 terminating at UE 2330 and host computer 2310. In providing the service to the remote user, host application 2312 may provide user data which is transmitted using OTT connection 2350.

Communication system 2300 further includes base station 2320, such as the network node 110, a provided in a telecommunication system and comprising hardware 2325 enabling it to communicate with host computer 2310 and with UE 2330. Hardware 2325 may include communication interface 2326 for setting up and maintaining a wired or wireless connection with an interface of a different communication device of communication system 2300, as well as radio interface 2327 for setting up and maintaining at least wireless connection 2370 with UE 2330, such as wireless device 130, located in a coverage area (not shown in FIG. 23) served by base station 2320. Communication interface 2326 may be configured to facilitate connection 2360 to host computer 2310. Connection 2360 may be direct or it may pass through a core network (not shown in FIG. 23) of the telecommunication system and/or through one or more intermediate networks outside the telecommunication system. In the embodiment shown, hardware 2325 of base station 2320 further includes processing circuitry 2328, which may comprise one or more programmable processors, application-specific integrated circuits, field programmable gate arrays or combinations of these (not shown) adapted to execute instructions. Base station 2320 further has software 2321 stored internally or accessible via an external connection.

Communication system 2300 further includes UE 2330 already referred to. Its hardware 2335 may include radio interface 2337 configured to set up and maintain wireless connection 2370 with a base station serving a coverage area in which UE 2330 is currently located. Hardware 2335 of UE 2330 further includes processing circuitry 2338, which may comprise one or more programmable processors, application-specific integrated circuits, field programmable gate arrays or combinations of these (not shown) adapted to execute instructions. UE 2330 further comprises software 2331, which is stored in or accessible by UE 2330 and executable by processing circuitry 2338. Software 2331 includes client application 2332. Client application 2332 may be operable to provide a service to a human or non-human user via UE 2330, with the support of host computer 2310. In host computer 2310, an executing host application 2312 may communicate with the executing client application 2332 via OTT connection 2350 terminating at UE 2330 and host computer 2310. In providing the service to the user, client application 2332 may receive request data from host application 2312 and provide user data in response to the request data. OTT connection 2350 may transfer both the request data and the user data. Client application 2332 may interact with the user to generate the user data that it provides.

It is noted that host computer 2310, base station 2320 and UE 2330 illustrated in FIG. 23 may be similar or identical to host computer 2230, one of base stations 2212a, 2212b, 2212c and one of UEs 2291, 2292 of FIG. 22, respectively. This is to say, the inner workings of these entities may be as shown in FIG. 23 and independently, the surrounding network topology may be that of FIG. 22.

In FIG. 23, OTT connection 2350 has been drawn abstractly to illustrate the communication between host computer 2310 and UE 2330 via base station 2320, without explicit reference to any intermediary devices and the precise routing of messages via these devices. Network infrastructure may determine the routing, which it may be configured to hide from UE 2330 or from the service provider operating host computer 2310, or both. While OTT connection 2350 is active, the network infrastructure may further take decisions by which it dynamically changes the routing (e.g., on the basis of load balancing consideration or reconfiguration of the network).

Wireless connection 2370 between UE 2330 and base station 2320 is in accordance with the teachings of the embodiments described throughout this disclosure. One or more of the various embodiments improve the performance of OTT services provided to UE 2330 using OTT connection 2350, in which wireless connection 2370 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 2350 between host computer 2310 and UE 2330, in response to variations in the measurement results. The measurement procedure and/or the network functionality for reconfiguring OTT connection 2350 may be implemented in software 2311 and hardware 2315 of host computer 2310 or in software 2331 and hardware 2335 of UE 2330, or both. In embodiments, sensors (not shown) may be deployed in or in association with communication devices through which OTT connection 2350 passes; the sensors may participate in the measurement procedure by supplying values of the monitored quantities exemplified above, or supplying values of other physical quantities from which software 2311, 2331 may compute or estimate the monitored quantities. The reconfiguring of OTT connection 2350 may include message format, retransmission settings, preferred routing etc.; the reconfiguring need not affect base station 2320, and it may be unknown or imperceptible to base station 2320. Such procedures and functionalities may be known and practiced in the art. In certain embodiments, measurements may involve proprietary UE signaling facilitating host computer 2310's measurements of throughput, propagation times, latency and the like. The measurements may be implemented in that software 2311 and 2331 causes messages to be transmitted, in particular empty or ‘dummy’ messages, using OTT connection 2350 while it monitors propagation times, errors etc.

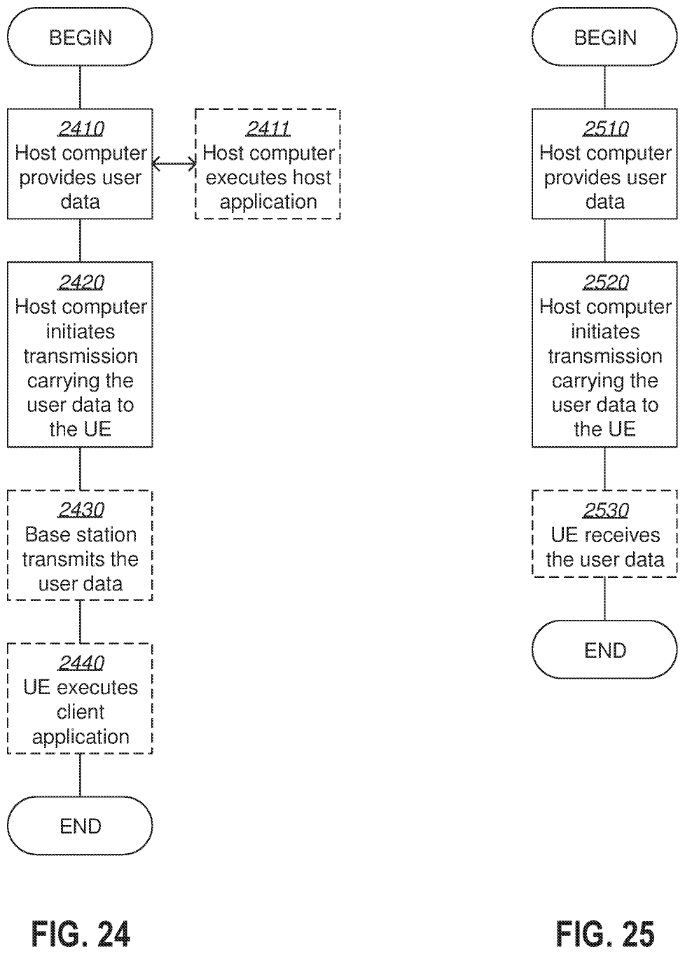

FIG. 24: Methods Implemented in a Communication System Including a Host Computer, a Base Station and a User Equipment in Accordance with Some Embodiments

FIG. 24 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 24 will be included in this section. In step 2410, the host computer provides user data. In substep 2411 (which may be optional) of step 2410, the host computer provides the user data by executing a host application. In step 2420, the host computer initiates a transmission carrying the user data to the UE. In step 2430 (which may be optional), the base station transmits to the UE the user data which was carried in the transmission that the host computer initiated, in accordance with the teachings of the embodiments described throughout this disclosure. In step 2440 (which may also be optional), the UE executes a client application associated with the host application executed by the host computer.

FIG. 25: Methods Implemented in a Communication System Including a Host Computer, a Base Station and a User Equipment in Accordance with Some Embodiments

FIG. 25 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 25 will be included in this section. In step 2510 of the method, the host computer provides user data. In an optional substep (not shown) the host computer provides the user data by executing a host application. In step 2520, the host computer initiates a transmission carrying the user data to the UE. The transmission may pass via the base station, in accordance with the teachings of the embodiments described throughout this disclosure. In step 2530 (which may be optional), the UE receives the user data carried in the transmission.

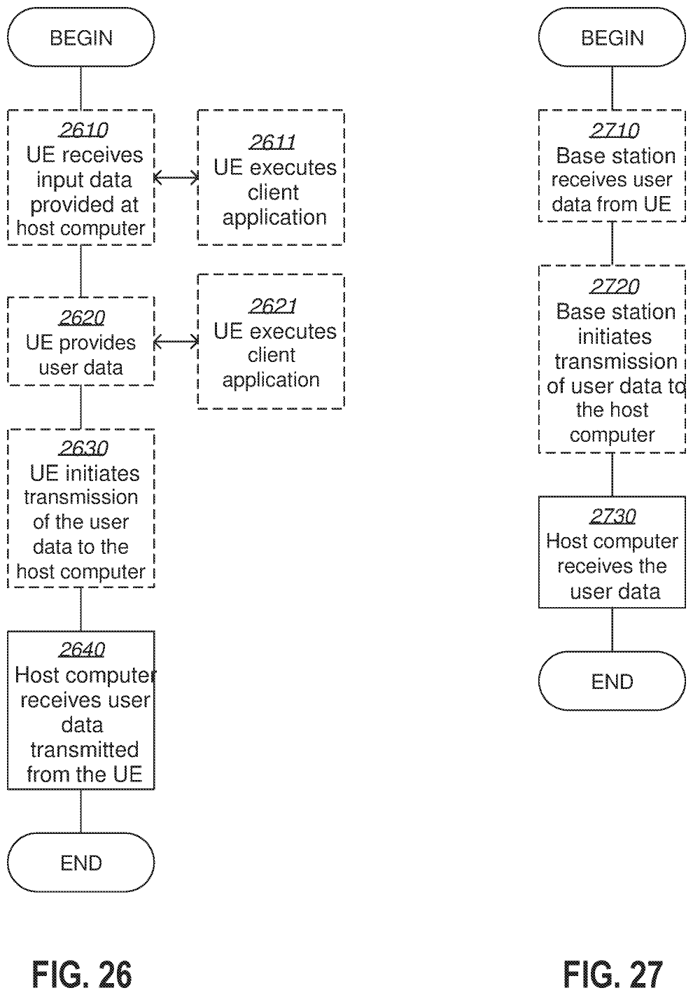

FIG. 26: Methods Implemented in a Communication System Including a Host Computer, a Base Station and a User Equipment in Accordance with Some Embodiments

FIG. 26 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 26 will be included in this section. In step 2610 (which may be optional), the UE receives input data provided by the host computer. Additionally or alternatively, in step 2620, the UE provides user data. In substep 2621 (which may be optional) of step 2620, the UE provides the user data by executing a client application. In substep 2611 (which may be optional) of step 2610, the UE executes a client application which provides the user data in reaction to the received input data provided by the host computer. In providing the user data, the executed client application may further consider user input received from the user. Regardless of the specific manner in which the user data was provided, the UE initiates, in substep 2630 (which may be optional), transmission of the user data to the host computer. In step 2640 of the method, the host computer receives the user data transmitted from the UE, in accordance with the teachings of the embodiments described throughout this disclosure.

FIG. 27: Methods Implemented in a Communication System Including a Host Computer, a Base Station and a User Equipment in Accordance with Some Embodiments

FIG. 27 is a flowchart illustrating a method implemented in a communication system, in accordance with one embodiment. The communication system includes a host computer, a base station and a UE which may be those described with reference to FIGS. 22 and 23. For simplicity of the present disclosure, only drawing references to FIG. 27 will be included in this section. In step 2710 (which may be optional), in accordance with the teachings of the embodiments described throughout this disclosure, the base station receives user data from the UE. In step 2720 (which may be optional), the base station initiates transmission of the received user data to the host computer. In step 2730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the radio network node 110.
5. A communication system including a host computer comprising:

processing circuitry configured to provide user data; and

a communication interface configured to forward the user data to a cellular network for transmission to a user equipment (UE),

wherein the cellular network comprises a base station having a radio interface and processing circuitry, the base station's processing circuitry configured to perform one or more of the actions described herein as performed by the radio network node 110.

6. The communication system of embodiment 5, further including the base station.
7. The communication system of embodiment 6, further including the UE, wherein the UE is configured to communicate with the base station.
8. The communication system of embodiment 7, wherein:

the processing circuitry of the host computer is configured to execute a host application, thereby providing the user data; and

the UE comprises processing circuitry configured to execute a client application associated with the host application.

11. A method implemented in a base station, comprising one or more of the actions described herein as performed by the radio network node 110.
15. A method implemented in a communication system including a host computer, a base station and a user equipment (UE), the method comprising:

at the host computer, providing user data; and

at the host computer, initiating a transmission carrying the user data to the UE via a cellular network comprising the base station, wherein the base station performs one or more of the actions described herein as performed by the radio network node 110.

16. The method of embodiment 15, further comprising:

at the base station, transmitting the user data.

17. The method of embodiment 16, wherein the user data is provided at the host computer by executing a host application, the method further comprising:

at the UE, executing a client application associated with the host application.

21. A user equipment (UE) configured to communicate with a base station, the UE comprising a radio interface and processing circuitry configured to perform one or more of the actions described herein as performed by the wireless device 130.
25. A communication system including a host computer comprising:

processing circuitry configured to provide user data; and

a communication interface configured to forward user data to a cellular network for transmission to a user equipment (UE),

wherein the UE comprises a radio interface and processing circuitry, the UE's processing circuitry configured to perform one or more of the actions described herein as performed by the wireless device 130.

26. The communication system of embodiment 25, further including the UE.
27. The communication system of embodiment 26, wherein the cellular network further includes a base station configured to communicate with the UE.
28. The communication system of embodiment 26 or 27, wherein:

the processing circuitry of the host computer is configured to execute a host application, thereby providing the user data; and

the UE's processing circuitry is configured to execute a client application associated with the host application.

31. A method implemented in a user equipment (UE), comprising one or more of the actions described herein as performed by the wireless device 130.
35. A method implemented in a communication system including a host computer, a base station and a user equipment (UE), the method comprising:

at the host computer, providing user data; and

at the host computer, initiating a transmission carrying the user data to the UE via a cellular network comprising the base station, wherein the UE performs one or more of the actions described herein as performed by the wireless device 130.

36. The method of embodiment 35, further comprising:

at the UE, receiving the user data from the base station.

41. A user equipment (UE) configured to communicate with a base station, the UE comprising a radio interface and processing circuitry configured to perform one or more of the actions described herein as performed by the wireless device 130.
45. A communication system including a host computer comprising:

a communication interface configured to receive user data originating from a transmission from a user equipment (UE) to a base station,

wherein the UE comprises a radio interface and processing circuitry, the UE's processing circuitry configured to: perform one or more of the actions described herein as performed by the wireless device 130.

46. The communication system of embodiment 45, further including the UE.
47. The communication system of embodiment 46, further including the base station, wherein the base station comprises a radio interface configured to communicate with the UE and a communication interface configured to forward to the host computer the user data carried by a transmission from the UE to the base station.
48. The communication system of embodiment 46 or 47, wherein:

the processing circuitry of the host computer is configured to execute a host application; and

the UE's processing circuitry is configured to execute a client application associated with the host application, thereby providing the user data.

49. The communication system of embodiment 46 or 47, wherein:

the processing circuitry of the host computer is configured to execute a host application, thereby providing request data; and

the UE's processing circuitry is configured to execute a client application associated with the host application, thereby providing the user data in response to the request data.

51. A method implemented in a user equipment (UE), comprising one or more of the actions described herein as performed by the wireless device 130.
52. The method of embodiment 51, further comprising:

providing user data; and

forwarding the user data to a host computer via the transmission to the base station.

55. A method implemented in a communication system including a host computer, a base station and a user equipment (UE), the method comprising:

at the host computer, receiving user data transmitted to the base station from the UE, wherein the UE performs one or more of the actions described herein as performed by the wireless device 130.

56. The method of embodiment 55, further comprising:

at the UE, providing the user data to the base station.

57. The method of embodiment 56, further comprising:

at the UE, executing a client application, thereby providing the user data to be transmitted; and

at the host computer, executing a host application associated with the client application.

58. The method of embodiment 56, further comprising:

at the UE, executing a client application; and

at the UE, receiving input data to the client application, the input data being provided at the host computer by executing a host application associated with the client application,

wherein the user data to be transmitted is provided by the client application in response to the input data.

61. A base station configured to communicate with a user equipment (UE), the base station comprising a radio interface and processing circuitry configured to perform one or more of the actions described herein as performed by the radio network node 110.
65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the radio network node 110.
66. The communication system of embodiment 65, further including the base station.
67. The communication system of embodiment 66, further including the UE, wherein the UE is configured to communicate with the base station.
68. The communication system of embodiment 67, wherein:

the processing circuitry of the host computer is configured to execute a host application;

the UE is configured to execute a client application associated with the host application, thereby providing the user data to be received by the host computer.

71. A method implemented in a base station, comprising one or more of the actions described herein as performed by the radio network node 110.
75. A method implemented in a communication system including a host computer, a base station and a user equipment (UE), the method comprising:

at the host computer, receiving, from the base station, user data originating from a transmission which the base station has received from the UE, wherein the UE performs one or more of the actions described herein as performed by the wireless device 130.

76. The method of embodiment 75, further comprising:

at the base station, receiving the user data from the UE.

77. The method of embodiment 76, further comprising:

at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
AMF Access and Mobility Management Function
E-SMLC Evolved-Serving Mobile Location Centre
FKP Flāhen Korrektur Parameter
GNSS Global Navigation Satellite System
LMF Location Management Function
MAC Master Auxiliary Concept
RTK Real Time Kinematic
SSR State space representation
VRS Virtual Reference Station
3GPP 3rd Generation Partnership Project
5G 5th Generation
CDMA Code Division Multiplexing Access
DL Downlink
E-SMLC Evolved-Serving Mobile Location Centre
eNB E-UTRAN NodeB
E-UTRA Evolved UTRA
E-UTRAN Evolved UTRAN
FDD Frequency Division Duplex
GERAN GSM EDGE Radio Access Network
gNB Base station in NR
GNSS Global Navigation Satellite System
GSM Global System for Mobile communication
LPP LTE Positioning Protocol
LTE Long-Term Evolution
MBMS Multimedia Broadcast Multicast Services
MDT Minimization of Drive Tests
MME Mobility Management Entity
MSC Mobile Switching Center
NR New Radio
OSS Operations Support System
OTDOA Observed Time Difference of Arrival
O&M Operation and Maintenance
RAN Radio Access Network
RAT Radio Access Technology
RNC Radio Network Controller
RRC Radio Resource Control
SIB System Information Block
SON Self Optimized Network
TDD Time Division Duplex
TDOA Time Difference of Arrival
TOA Time of Arrival
UE User Equipment
UL Uplink
UMTS Universal Mobile Telecommunication System
UTDOA Uplink Time Difference of Arrival
UTRA Universal Terrestrial Radio Access
UTRAN Universal Terrestrial Radio Access Network
WCDMA Wide CDMA
WLAN Wide Local Area Network

### REFERENCES

[1] 3GPP TS 36.355, Evolved Universal Terrestrial Radio Access (E-UTRA); LTE Positioning Protocol (LPP)
[2] 3GPP TS 36.455, Evolved Universal Terrestrial Radio Access (E-UTRA); LTE Positioning Protocol A (LPPa)

1-76. (canceled)

77. A method, performed by a first node, for handling assistance data about a location of a second node, the first node and the second node operating in a wireless communications network, the method comprising:
determining a first set of the assistance data to be provided to the second node via unicast, and a second set of the assistance data to be provided to the second node via broadcast, wherein the determining is based on one or more characteristics of at least one of: the second node, the assistance data, the wireless communications network, and the radio coverage of the second node, and
sending, to at least one of: the second node and a third node operating in the wireless communications network, the first set of the assistance data via unicast, and the second set of the assistance data via broadcast.

78. The method of claim 77, further comprising:
initiating providing, to the second node, an indication indicating the first set of the assistance data to be provided to the second node via unicast, and the second set of the assistance data to be provided to the second node via broadcast.

79. The method of claim 77, wherein at least one of:
a. the one or more characteristics of the second node comprise a capability of the second node;
b. the one or more characteristics of the assistance data comprise at least one of: a) information on a validity of the first set of the assistance data and second set of the assistance data, and b) an interest on the first set of the assistance data and second set of the assistance data;
c. the one or more characteristics of the wireless communications network comprise at least one of: a load of the wireless communications network and an efficiency of provisioning of the assistance data to the second node; and
d. the one or more characteristics of the radio coverage of the second node comprise one of: a) a potential beamforming gain of a unicast transmission or a broadcast transmission, and b) a radio condition information provided by the second node in a request for the assistance data.

80. The method of claim 77, wherein, based on the determining, the first set of the assistance data comprises at least one of:
i. data supported by a lower number of devices in the wireless communications network than the data in the second set of assistance data;
ii. data with a longer validity than the data in the second set of assistance data,
iii. data to be provided at a lower frequency than data in the second set of assistance data,
iv. data with a higher security sensitivity than data in the second set of assistance data,
v. data for users with a higher priority than users of the data in the second set of assistance data,
vi. data of interest to a lower number of devices in the wireless communications network than the data in the second set of assistance data,
vii. data to be provided in low load conditions of the wireless communications network,
viii. data to be provided with higher efficiency than via broadcast,
ix. data to be provided with higher beamforming gain than with broadcast transmission, and
x. data to be provided with better radio coverage than with broadcast transmission.

81. The method of claim 77, wherein the method further comprises:
obtaining, from the second node, a first indication indicating a capability the second node, the capability being about positioning, and
wherein the one or more characteristics of the second node are indicated by the obtained first indication.

82. The method of claim 81, wherein the first indication indicates whether or not the second node supports detection of positioning broadcast information while in connected mode.

83. The method of claim 77, wherein the method further comprises:
obtaining, from the second node, a second indication indicating a scope of assistance data to be requested by the second node, and
wherein the one or more characteristics of the assistance data are indicated by the obtained second indication.

84. The method of claim 77, wherein the method further comprises:
obtaining, from a third node, at least a third indication indicating at least one of: a load of the wireless communications network and an efficiency of provisioning of the assistance data to the second node, and wherein the one or more characteristics of the wireless communications network are indicated by the obtained third indication.

85. The method of claim 77, wherein the third node is a radio network node, and wherein the first node sends the second set of the assistance data via broadcast, to the second node via the radio network node.

86. The method of claim 77, wherein the third node is a mobility management entity, and wherein the first node sends the first set of the assistance data via unicast, to the second node via the mobility management entity.

87. A method, performed by a second node, for handling assistance data about a location of the second node, the second node operating in a wireless communications network, the method comprising:
retrieving, from a first node operating in the wireless communications network, a first set of the assistance data via unicast, and a second set of the assistance data via broadcast, wherein the retrieving is based on one or more characteristics of at least one of: the second node, the assistance data, the wireless communications network, and the radio coverage of the second node, and
initiating using at least one of the retrieved first set of the assistance data and second set of the assistance data, to facilitate a positioning measurement.

88. The method of claim 87, further comprising:
obtaining, from the first node, an indication about the first set of the assistance data to be provided via unicast, and the second set of the assistance data to be provided via broadcast, wherein the obtaining is based on one or more characteristics of at least one of: the second node, the assistance data, the wireless communications network, and the radio coverage of the second node.

89. The method of claim 87, wherein at least one of:
a. the one or more characteristics of the second node comprise a capability of the second node;
b. the one or more characteristics of the assistance data comprise at least one of: a) information on a validity of the first set of the assistance data and second set of the assistance data, and b) an interest on the first set of the assistance data and second set of the assistance data;
c. the one or more characteristics of the wireless communications network comprise at least one of: a load of the wireless communications network and an efficiency of provisioning of the assistance data to the second node; and
d. the one or more characteristics of the radio coverage of the second node comprise one of: a) a potential beamforming gain of a unicast transmission or a broadcast transmission, and b) a radio condition information provided by the second node in a request for the assistance data.

90. The method of claim 87, wherein the first set of the assistance data comprises at least one of:
i. data supported by a lower number of devices in the wireless communications network than the data in the second set of assistance data,
ii. data with a longer validity than the data in the second set of assistance data,
iii. data to be provided at a lower frequency than data in the second set of assistance data,
iv. data with a higher security sensitivity than data in the second set of assistance data,
v. data for users with a higher priority than users of the data in the second set of assistance data,
vi. data of interest to a lower number of devices in the wireless communications network than the data in the second set of assistance data,
vii. data to be provided in low load conditions of the wireless communications network,
viii. data to be provided with higher efficiency than via broadcast,
ix. data to be provided with higher beamforming gain than with broadcast transmission, and
x. data to be provided with better radio coverage than with broadcast transmission.

91. The method of claim 87, wherein the method further comprises:
providing, to the first node, a first indication indicating a capability the second node, the capability being about positioning, and
wherein the one or more characteristics of the second node are indicated by the provided first indication.

92. The method of claim 91, wherein the first indication indicates whether the second node supports detection of positioning broadcast information while in connected mode.

93. The method of claim 87, wherein the method further comprises:
providing, to the first node, a second indication indicating a scope of assistance data to be requested by the second node, and
wherein the one or more characteristics of the assistance data are indicated by the provided second indication.

94. A method, performed by a radio network node, for handling assistance data about a location of a second node, the radio network node and the second node operating in a wireless communications network, the method comprising:
receiving, from a first node operating in the wireless communications network a first set of the assistance data to be provided to the second node via unicast, and a second set of the assistance data to be provided to the second node via broadcast, wherein the receiving is based on one or more characteristics of at least one of: the second node, the assistance data, the wireless communications network, and the radio coverage of the second node, and
sending, to the second node, the first set of the assistance data via unicast, and the second set of the assistance data via broadcast.

95. The method of claim 94, further comprising:
receiving, from the first node, an indication indicating the first set of the assistance data to be provided to the second node via unicast, and the second set of the assistance data to be provided to the second node via broadcast; and
sending the received indication to the second node.

96. The method of claim 94, wherein at least one of:
a. the one or more characteristics of the second node comprise a capability of the second node;
b. the one or more characteristics of the assistance data comprise at least one of: a) information on a validity of the first set of the assistance data and second set of the assistance data, and b) an interest on the first set of the assistance data and second set of the assistance data;
c. the one or more characteristics of the wireless communications network comprise at least one of: a load of the wireless communications network and an efficiency of provisioning of the assistance data to the second node; and
d. the one or more characteristics of the radio coverage of the second node comprise one of: a) a potential beamforming gain of a unicast transmission or a broadcast transmission, and b) a radio condition information provided by the second node in a request for the assistance data.

97. The method of claim 94, wherein the first set of the assistance data comprises at least one of:
i. data supported by a lower number of devices in the wireless communications network than the data in the second set of assistance data,
ii. data with a longer validity than the data in the second set of assistance data,
iii. data to be provided at a lower frequency than data in the second set of assistance data,
iv. data with a higher security sensitivity than data in the second set of assistance data,
v. data for users with a higher priority than users of the data in the second set of assistance data,
vi. data of interest to a lower number of devices in the wireless communications network than the data in the second set of assistance data,
vii. data to be provided in low load conditions of the wireless communications network,
viii. data to be provided with higher efficiency than via broadcast,
ix. data to be provided with higher beamforming gain than with broadcast transmission, and
x. data to be provided with better radio coverage than with broadcast transmission.

98. A method, performed by a mobility management entity, for handling assistance data about a location of a second node, the mobility management entity and the second node operating in a wireless communications network, the method comprising:
receiving, from a first node operating in the wireless communications network a first set of the assistance data to be provided to the second node via unicast, and a second set of the assistance data to be provided to the second node via broadcast, wherein the receiving is based on one or more characteristics of at least one of: the second node, the assistance data, the wireless communications network, and the radio coverage of the second node, and
sending, to the second node, the first set of the assistance data via unicast, and the second set of the assistance data via broadcast.

99. The method of claim 98, further comprising:
receiving, from the first node, an indication indicating the first set of the assistance data to be provided to the second node via unicast, and the second set of the assistance data to be provided to the second node via broadcast; and
sending the received indication to the second node.

100. The method of claim 98, wherein at least one of:
a. the one or more characteristics of the second node comprise a capability of the second node;
b. the one or more characteristics of the assistance data comprise at least one of: a) information on a validity of the first set of the assistance data and second set of the assistance data, and b) an interest on the first set of the assistance data and second set of the assistance data;
c. the one or more characteristics of the wireless communications network comprise at least one of: a load of the wireless communications network and an efficiency of provisioning of the assistance data to the second node; and
d. the one or more characteristics of the radio coverage of the second node comprise one of: a) a potential beamforming gain of a unicast transmission or a broadcast transmission, and b) a radio condition information provided by the second node in a request for the assistance data.

101. A first node configured to handle assistance data about a location of a second node, the first node and the second node being configured to operate in a wireless communications network, the first node comprising a processor and a memory operatively coupled to the processor, the memory storing instructions configured to cause the first node, when the instructions are executed by the processor, to:
determine a first set of the assistance data to be provided to the second node via unicast, and a second set of the assistance data to be provided to the second node via broadcast, wherein to determine is configured to be based on one or more characteristics of at least one of: the second node, the assistance data, the wireless communications network, and the radio coverage of the second node, and
send, to at least one of: the second node and a third node configured to operate in the wireless communications network, the first set of the assistance data via unicast, and the second set of the assistance data via broadcast.

102. A second node configured to handle assistance data about a location of the second node, the second node being configured to operate in a wireless communications network, the second node comprising a processor and a memory operatively coupled to the processor, the memory storing instructions configured to cause the second node, when the instructions are executed by the processor, to:
retrieve, from a first node configured to operate in the wireless communications network, a first set of the assistance data via unicast, and a second set of the assistance data via broadcast, wherein to retrieve is configured to be based on one or more characteristics of at least one of: the second node, the assistance data, the wireless communications network, and the radio coverage of the second node, and
initiate using at least one of the first set of the assistance data and second set of the assistance data configured to be retrieved, to facilitate a positioning measurement.
